(19) United States
(12) Patent Application Publication
(10) Pub. No.: US 2024/0369123 A1
(43) Pub. Date: Nov. 7, 2024

(54) SHOCK ABSORBER

(71) Applicant: HITACHI ASTEMO, LTD., Ibaraki (JP)

(72) Inventor: Yuta YAMAGUCHI, Hitachinaka-shi (JP)

(21) Appl. No.: 18/689,886

(22) PCT Filed: Dec. 7, 2022
(86) PCT No.: PCT/JP2022/045080

§ 371 Date: Mar. 7, 2024

(30) Foreign Application Priority Data
Dec. 7, 2021 (JP) 2021-198327

(51) Int. Cl. F16F 9/504; F16F 9/18; F16F 9/32; F16F 9/34

(52) U.S. Cl. CPC F16F 9/504; F16F 9/185; F16F 9/3257; F16F 9/34; F16F 2222/12; F16F 2228/04; F16F 2228/066; F16F 2230/36; F16F 2234/02

(57) ABSTRACT

Provided is a shock absorber having a cylinder having a bottomed cylindrical shape in which a working fluid is sealed, a piston provided inside the cylinder and dividing the inside of the cylinder into two cylinder chambers, a piston rod to which the piston is fastened, and a reservoir chamber in which the working fluid and a gas are sealed, and the shock absorber includes a partition member partitioning the cylinder chamber in the cylinder and the reservoir chamber and including a first partition member having a first flow path which allows communication between the cylinder chamber and the reservoir chamber, and a frequency sensitive part provided on a bottom part side of the cylinder with respect to the first partition member and to which the working fluid is supplied through the first flow path.

### TECHNICAL FIELD

The present invention relates to a shock absorber.

Priority is claimed on Japanese Patent Application No. 2021-198327 filed on Dec. 7, 2021, the content of which is incorporated herein by reference.

### BACKGROUND ART

Some shock absorbers include a partition member provided on a bottom part side of a cylinder and partitioning a chamber in the cylinder and a reservoir chamber. In this type of shock absorber, there is one in which a frequency sensitive part is provided in the partition member (for example, see Patent Documents 1 and 2).

### CITATION LIST

### Patent Document

### [Patent Document 1]

Japanese Unexamined Patent Application, First Publication No. 2015-59641

### [Patent Document 2]

Japanese Unexamined Patent Application, First Publication No. 2014-185686

### SUMMARY OF INVENTION

### Technical Problem

In the shock absorber described above, there is a likelihood that a flow path area of a flow path through which a working fluid is introduced into the frequency sensitive part cannot be secured.

Therefore, an objective of the present invention is to provide a shock absorber in which a flow path area of a flow path through which a working fluid is introduced into a frequency sensitive part can be secured.

### Solution to Problem

In order to achieve the above-described objective, a first aspect of the present invention is a shock absorber having a cylinder having a bottomed cylindrical shape in which a working fluid is sealed, a piston provided inside the cylinder and dividing an inside of the cylinder into two cylinder chambers, a piston rod to which the piston is fastened, and a reservoir chamber in which the working fluid and a gas are sealed, and the shock absorber includes a partition member partitioning the cylinder chamber in the cylinder and the reservoir chamber and including a first partition member having a first flow path which allows communication between the cylinder chamber and the reservoir chamber, and a frequency sensitive part provided on a bottom part side of the cylinder with respect to the first partition member and to which the working fluid is supplied through the first flow path.

### Advantageous Effects of Invention

According to the present invention, it is possible to secure a flow path area of the flow path through which a working fluid is introduced into the frequency sensitive part.

### BRIEF DESCRIPTION OF DRAWINGS

FIG. 1 is a cross-sectional view illustrating a shock absorber of a first embodiment according to the present invention.

FIG. 2 is a plan view illustrating a base valve of the shock absorber of the first embodiment according to the present invention.

FIG. 3 is a cross-sectional view along line III-III in FIG. 2 illustrating the base valve and the like of the shock absorber of the first embodiment according to the present invention.

FIG. 4 is a one-sided cross-sectional view illustrating a frequency sensitive part and the like of the shock absorber of the first embodiment according to the present invention.

FIG. 5 is a cross-sectional view illustrating a base valve and the like of a shock absorber of a second embodiment according to the present invention.

FIG. 6 is a cross-sectional view illustrating a base valve and the like of a shock absorber of a third embodiment according to the present invention.

FIG. 7 is a cross-sectional view illustrating a base valve and the like of a shock absorber of a fourth embodiment according to the present invention.

FIG. 8 is a cross-sectional view of a main part illustrating the base valve and the like of the shock absorber of the fourth embodiment according to the present invention.

### DESCRIPTION OF EMBODIMENTS

### First Embodiment

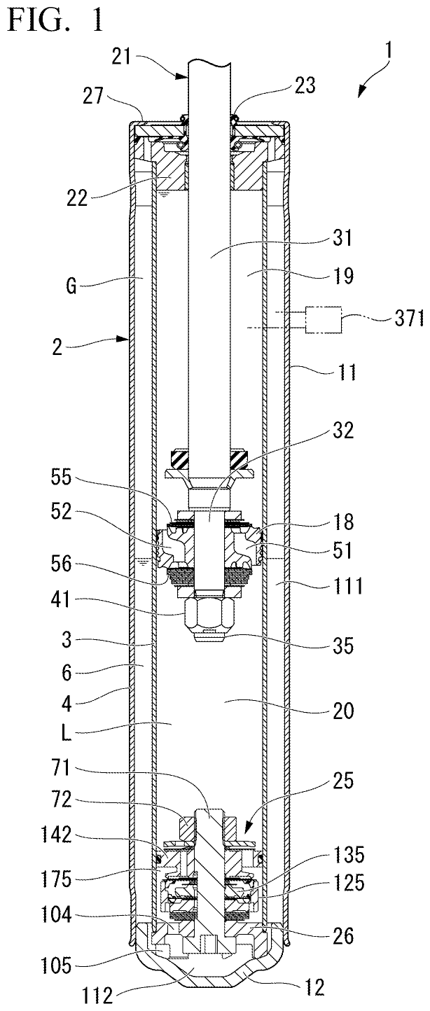

A shock absorber according to a first embodiment will be described below with reference to the drawings. Further, in the following, for convenience of explanation, an upper side in FIGS. 1 to 6 will be referred to using “upper” and a lower side in FIGS. 1 to 6 will be referred to using “lower”.

As illustrated in FIG. 1, a shock absorber 1 of the first embodiment is a dual-tube type hydraulic shock absorber. The shock absorber 1 is used in suspension devices of vehicles, specifically, automobiles. The shock absorber 1 includes a cylinder 2 in which a working fluid L such as an oil fluid is sealed as a working fluid. The cylinder 2 has an inner cylinder 3 and an outer cylinder 4. The inner cylinder 3 has a cylindrical shape. The outer cylinder 4 has a bottomed cylindrical shape. An inner diameter of the outer cylinder 4 is larger than an outer diameter of the inner cylinder 3. The inner cylinder 3 is disposed on a radially inner side of the outer cylinder 4. Therefore, the cylinder 2 has a bottomed cylindrical shape as a whole. A central axis of the inner cylinder 3 coincides with a central axis of the outer cylinder 4. A reservoir chamber 6 is provided between the inner cylinder 3 and the outer cylinder 4.

The outer cylinder 4 includes a barrel part 11 and a bottom part 12. The barrel part 11 has a cylindrical shape. The bottom part 12 closes a lower portion of the barrel part 11. A mounting eye (not illustrated) is fixed to the bottom part 12 on an outer side opposite to the barrel part 11 in an axial direction thereof.

The shock absorber 1 includes a piston 18. The piston 18 is provided inside the inner cylinder 3 of the cylinder 2. The piston 18 is slidably fitted in the inner cylinder 3 of the cylinder 2. The piston 18 divides the inside of the inner cylinder 3 of the cylinder 2 into two chambers, an upper chamber 19 (cylinder chamber) on one side and a lower chamber 20 (cylinder chamber) on the other side. The upper chamber 19 and the lower chamber 20 are cylinder chambers formed inside the cylinder 2. In an axial direction of the cylinder 2, the upper chamber 19 is on a side opposite to the bottom part 12 with respect to the piston 18. In the axial direction of the cylinder 2, the lower chamber 20 is on the bottom part 12 side with respect to the piston 18. A working fluid L is sealed in the upper chamber 19 and the lower chamber 20 in the inner cylinder 3 as a working fluid. The working fluid L and a gas G are sealed in the reservoir chamber 6 between the inner cylinder 3 and the outer cylinder 4 as a working fluid.

The shock absorber 1 includes a piston rod 21. One end side of the piston rod 21 in the axial direction is disposed in the inner cylinder 3 of the cylinder 2. The piston 18 is fastened to this one end portion of the piston rod 21. The other end side of the piston rod 21 on a side opposite to the one end portion in the axial direction extends from the cylinder 2 to the outside of the cylinder 2. The piston 18 is fixed to the piston rod 21. Therefore, the piston 18 and the piston rod 21 move together.

In the shock absorber 1, a stroke in which the piston rod 21 moves in a direction to increase an amount of protrusion from the cylinder 2 is an extension stroke in which the entire length increases. Of moving directions of the piston rod 21, a direction in which an amount of protrusion from the inner cylinder 3 and the outer cylinder 4 is increased is defined as an extension side. In the shock absorber 1, the piston 18 moves to the upper chamber 19 side during the extension stroke.

In the shock absorber 1, a stroke in which the piston rod 21 moves in a direction to reduce an amount of protrusion from the cylinder 2 is a compression stroke in which the entire length is reduced. Of the moving directions of the piston rod 21, a direction in which an amount of entry into the inner cylinder 3 and the outer cylinder 4 is increased is defined as a compression side. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted to the outer cylinder 4 above the rod guide 22. The rod guide 22 and the seal member 23 are both annular. The piston rod 21 slides with respect to the rod guide 22 and the seal member 23 in an axial direction of them. The piston rod 21 extends from the inside of the cylinder 2 to the outside of the cylinder 2 with respect to the seal member 23.

The rod guide 22 restricts movement of the piston rod 21 in a radial direction with respect to the inner cylinder 3 and outer cylinder 4 of the cylinder 2. The piston rod 21 is fitted in the rod guide 22, and the piston 18 is fitted in the inner cylinder 3. Thereby, a central axis of the piston rod 21 and a central axis of the cylinder 2 coincide with each other. The rod guide 22 supports the piston rod 21 to be movable in an axial direction of the piston rod 21. An outer circumferential portion of the seal member 23 is in close contact with the outer cylinder 4. An inner circumferential portion of the seal member 23 is in close contact with an outer circumferential portion of the piston rod 21. The piston rod 21 moves in the axial direction of the seal member 23 with respect to the seal member 23. The seal member 23 curbs the working fluid L in the inner cylinder 3, and the high-pressure gas G and the working fluid L in the reservoir chamber 6 leaking to the outside.

An outer circumferential portion of the rod guide 22 has a larger diameter at an upper portion than at a lower portion. The rod guide 22 is fitted to an inner circumferential portion of an upper end of the inner cylinder 3 at the lower portion with a smaller diameter. The rod guide 22 is fitted to an upper inner circumferential portion of the barrel part 11 of the outer cylinder 4 at the upper portion with a larger diameter.

A base valve 25 (partition member) is installed above the bottom part 12 of the outer cylinder 4. The base valve 25 includes a base member 26 (second partition member) and is installed above the bottom part 12 in the base member 26. The base member 26 is positioned in the radial direction with respect to the outer cylinder 4. Thereby, the base valve 25 is also positioned in the radial direction with respect to the outer cylinder 4. An inner circumferential portion at a lower end of the inner cylinder 3 is fitted to the base member 26.

An upper end portion of the outer cylinder 4 is swaged inward in the radial direction of the outer cylinder 4 to form a locking part 27. The seal member 23 is fixed to the cylinder 2 by being sandwiched between the locking part 27 and the rod guide 22. When the locking part 27 is formed, an axial force of the inner cylinder 3 is applied to the base member 26 via the seal member 23 and the rod guide 22.

The piston rod 21 includes a main shaft part 31 and a mounting shaft part 32. Both the main shaft part 31 and the mounting shaft part 32 have a rod shape.

The mounting shaft part 32 has an outer diameter smaller than an outer diameter of the main shaft part 31. The mounting shaft part 32 is disposed inside the cylinder 2. The piston 18 is attached to the mounting shaft part 32. An end surface of the main shaft part 31 on the mounting shaft part 32 side in the axial direction extends in a direction orthogonal to the central axis of the piston rod 21. The mounting shaft part 32 includes a screw part 35 formed at an outer circumferential portion of an end portion of the mounting shaft part 32 on a side opposite to the main shaft part 31 in the axial direction. A nut 41 is screwed onto the screw part 35. The piston 18 is fixed to the piston rod 21 with the nut 41.

The dual-tube type shock absorber 1 is connected to a vehicle body of a vehicle with a portion of the piston rod 21 protruding from the cylinder 2 disposed at an upper portion. At that time, the shock absorber 1 is connected to a wheel side of the vehicle with the mounting eye (not illustrated) provided on the cylinder 2 side disposed at a lower portion. On the other hand, in a single-tube type shock absorber, since there is no likelihood of air being trapped, the cylinder 2 side thereof may be connected to the vehicle body, contrary to the dual-tube type shock absorber. In this case, in the shock absorber 1, the piston rod 21 is connected to the wheel side.

A passage 51 and a passage 52 are formed in the piston 18. The passages 51 and 52 penetrate the piston 18 in an axial direction of the piston 18. The passages 51 and 52 allow communication between the upper chamber 19 and the lower chamber 20. The shock absorber 1 includes a disc valve 55. The disc valve 55 is provided on a side of the piston 18 opposite to the bottom part 12 in the axial direction. The disc valve 55 has an annular shape and closes the passage 51 by coming into contact with the piston 18. The shock absorber 1 includes a disc valve 56. The disc valve 56 is provided on the bottom part 12 side of the piston 18 in the axial direction. The disc valve 56 has an annular shape and closes the passage 52 by coming into contact with the piston 18.

When the piston rod 21 moves to the compression side, the piston 18 moves in a direction in which the lower chamber 20 is reduced. As a result, when a pressure in the lower chamber 20 becomes higher than a pressure in the upper chamber 19 by a predetermined value or higher, the disc valve 55 opens the passage 51 to allow the working fluid L of the lower chamber 20 to flow into the upper chamber 19. At that time, the disc valve 55 generates a damping force.

When the piston rod 21 moves to the extension side, the piston 18 moves in a direction in which the upper chamber 19 is reduced. As a result, when a pressure in the upper chamber 19 becomes higher than a pressure in the lower chamber 20 by a predetermined value or higher, the disc valve 56 opens the passage 52 to allow the working fluid L of the upper chamber 19 to flow into the lower chamber 20. At that time, the disc valve 56 generates a damping force.

A fixed orifice (not illustrated) is formed in at least one of the piston 18 and the disc valve 55. This fixed orifice allows the upper chamber 19 and the lower chamber 20 to communicate with each other via the passage 51 even in a state in which the disc valve 55 has closed the passage 51 to the maximum. Also, a fixed orifice (not illustrated) is formed in at least one of the piston 18 and the disc valve 56. This fixed orifice allows the upper chamber 19 and the lower chamber 20 to communicate with each other via the passage 52 even in a state in which the disc valve 56 has closed the passage 52 to the maximum.

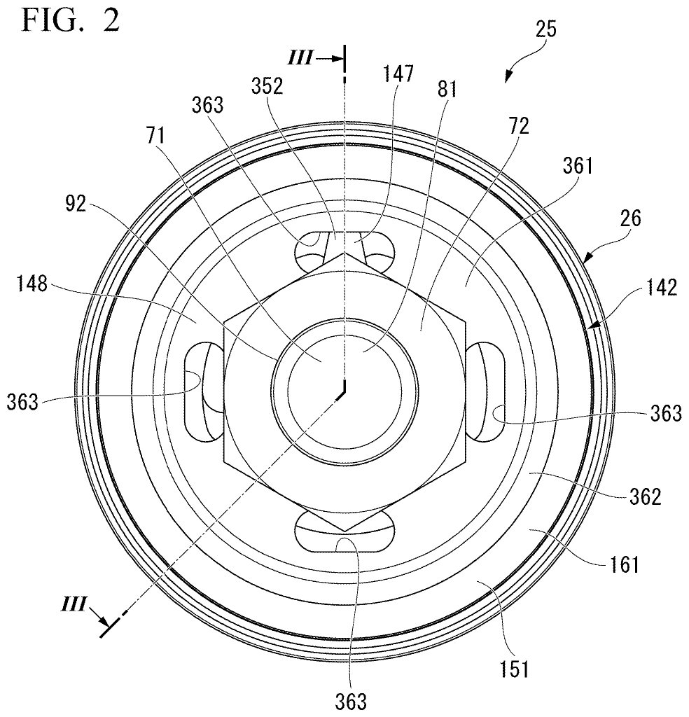

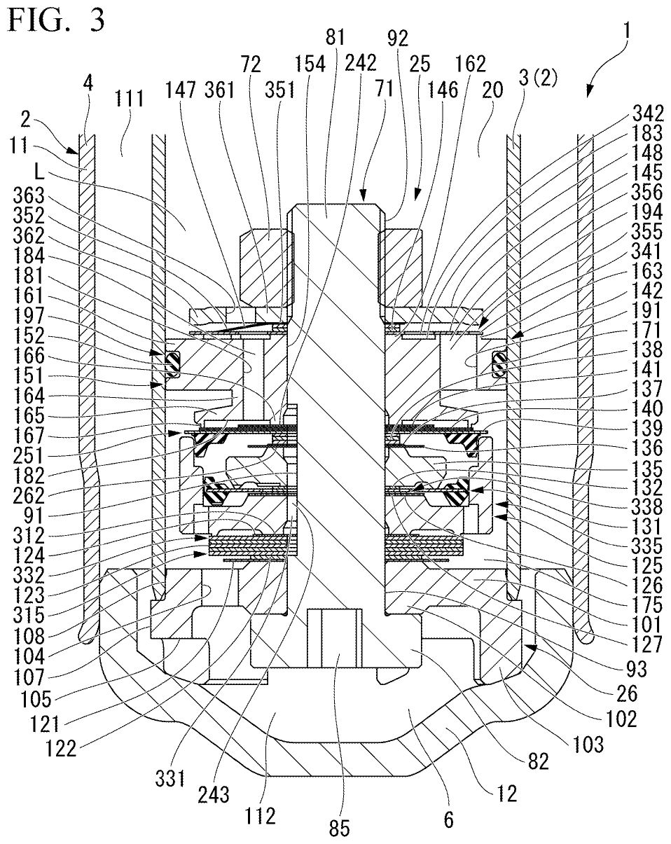

The base valve 25 includes a pin member 71 (shaft member) and a nut member 72 as illustrated in FIGS. 2 and 3.

The pin member 71 is made of a metal and is a shaft-shaped shaft member. The pin member 71 includes a shaft part 81 and a head part 82 as illustrated in FIG. 3. The shaft part 81 has a columnar shape. The head part 82 has a disc shape. The head part 82 is disposed at one end portion of the shaft part 81 in the axial direction. Central axes of the shaft part 81 and the head part 82 coincide with each other. An outer diameter of the shaft part 81 is smaller than an outer diameter of the head part 82. A hexagonal engagement hole 85 with which a tool is engaged is formed in the head part 82. The engagement hole 85 is formed at an end surface of the head part 82 on a side opposite to the shaft part 81 in the axial direction. The engagement hole 85 is formed to be recessed from the end surface to the shaft part 81 side in the axial direction of the head part 82. The end surface of the head part 82 on the shaft part 81 side in the axial direction extends in a direction orthogonal to a central axis of the pin member 71.

A groove part 91 is formed in the pin member 71 at an outer circumferential portion of the shaft part 81. The groove part 91 extends in an axial direction of the shaft part 81. The groove part 91 is formed by cutting out the outer circumferential portion of the shaft part 81 into a planar shape parallel to the central axis of the shaft part 81. The groove parts 91 are formed at two locations (only one is illustrated in FIG. 3 because it is a cross section) at intervals in a circumferential direction of the shaft part 81. The two groove parts 91 are disposed at regular intervals in the circumferential direction of the shaft part 81. A screw part 92 is formed in the shaft part 81 at an outer circumferential portion of the shaft part 81 on a side opposite to the head part 82 with respect to the groove part 91 in the axial direction. The shaft part 81 has a fitting shaft part 93 in a portion other than a portion in which the screw part 92 is formed. The groove part 91 is formed in the fitting shaft part 93. The groove part 91 is recessed inward in a radial direction of the fitting shaft part 93 from an outer circumferential surface of the fitting shaft part 93.

The base valve 25 includes the base member 26 as described above. The base member 26 is formed of a metal, ceramics, or the like. The base member 26 is seamlessly integrally formed in its entirety. The base member 26 has a disc-shaped part 101, an inner cylindrical part 102, and a leg part 103.

The disc-shaped part 101 has a plate shape and has an annular shape. A through hole 104 penetrating the disc-shaped part 101 in the axial direction is formed in the disc-shaped part 101,

The inner cylindrical part 102 has a cylindrical shape and is formed at an inner circumferential portion of the disc-shaped part 101. The inner cylindrical part 102 protrudes from the disc-shaped part 101 to both sides in an axial direction of the disc-shaped part 101.

The leg part 103 has a cylindrical shape and is formed at an outer circumferential portion of the disc-shaped part 101. The leg part 103 protrudes from the disc-shaped part 101 to one side in the axial direction of the disc-shaped part 101. The leg part 103 includes a through groove 105 formed to penetrate the leg part 103 in the radial direction. The through groove 105 is formed in a portion of the leg part 103 on a side opposite to the disc-shaped part 101 in the axial direction. A plurality of through grooves 105 are formed in the leg part 103 (only one is illustrated in FIG. 3 because it is a cross section). These through grooves 105 are disposed at regular intervals in a circumferential direction of the leg part 103. As illustrated in FIG. 1, when the through grooves 105 are formed in the base member 26, a portion between the bottom part 12 of the outer cylinder 4 and the base member 26 communicates with a portion between the barrel part 11 of the outer cylinder 4 and the inner cylinder 3. Therefore, the portion between the bottom part 12 of the outer cylinder 4 and the base member 26 also serves as the reservoir chamber 6. The reservoir chamber 6 includes a cylindrical chamber 111 having a cylindrical shape between the barrel part 11 and the inner cylinder 3, a bottom chamber 112 between the bottom part 12 and the base member 26, and an outer circumferential chamber 175 to be described later.

As illustrated in FIG. 3, a large diameter portion 107 and a small diameter portion 108 are formed on outer circumferential portions of the disc-shaped part 101 and the leg part 103. An outer diameter of the large diameter portion 107 is larger than an outer diameter of the small diameter portion 108. Of the disc-shaped part 101 and the leg part 103, the large diameter portion 107 is formed on the leg part 103 side. Of the disc-shaped part 101 and the leg part 103, the small diameter portion 108 is formed on the disc-shaped part 101 side. The through grooves 105 are formed in a portion of the large diameter portion 107 on a side opposite to the small diameter portion 108 in the axial direction. In the base member 26, the inner circumferential portion at the lower end of the inner cylinder 3 is fitted on the small diameter portion 108.

In the base member 26, the fitting shaft part 93 of the pin member 71 is fitted in an inner circumferential side of the inner cylindrical part 102. In the base member 26, an end portion of the inner cylindrical part 102 on the same side as a side in which the leg part 103 extends from the disc-shaped part 101 in the axial direction is in contact with the head part 82 of the pin member 71.

The base valve 25 includes one disc 121, one disc 122, a plurality of (specifically, five) discs 123, one disc 124, one pilot case 125, one disc 126, and one disc 127 on a side of the inner cylindrical part 102 of the base member 26 opposite to the leg part 103 in the axial direction in order from the base member 26 side.

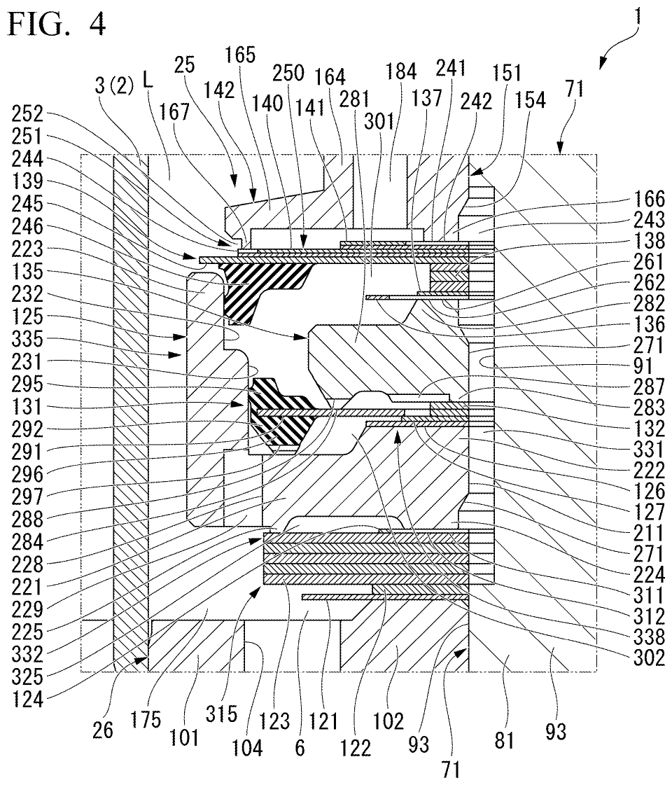

Also, as illustrated in FIG. 4, the base valve 25 includes one valve member 131 and a plurality of (specifically, two) discs 132 on a side of the disc 127 opposite to the disc 126 in the axial direction.

Also, the base valve 25 includes one pilot case retainer 135, one disc 136, one disc 137, a plurality of (specifically, three) discs 138, one pilot disc 139, a plurality of (specifically, two) discs 140, a plurality of (specifically, two) discs 141, and a partition member 142 (first partition member) on a side of the valve member 131 and the discs 132 opposite to the disc 127 in the axial direction in order from a side of the valve member 131 and the discs 132.

Also, the base valve 25 includes a plurality of or one valve disc 145, a plurality of (specifically, two) discs 146, one spring disc 147, and one restriction disc 148 on a side of the partition member 142 opposite to the discs 141 in the axial direction in order from the partition member 142 side.

The discs 121 to 124, 126, 127, 132, 136 to 138, 140, 141, and 146, the pilot case 125, the pilot case retainer 135, the pilot disc 139, the partition member 142, the valve disc 145, the spring disc 147, and the restriction disc 148 all have the shaft part 81 of the pin member 71 fitted to an inner circumferential side of them. The discs 121 to 124, 126, 127, 132, 136 to 138, 140, 141, and 146, the pilot case 125, the pilot case retainer 135, the pilot disc 139, the partition member 142, the valve disc 145, the spring disc 147, and the restriction disc 148 are clamped by the head part 82 of the pin member 71 and the nut member 72 at least at their inner circumferential side. As illustrated in FIG. 4, the discs 132 and the fitting shaft part 93 of the pin member 71 are inserted through an inner circumferential side of the valve member 131.

As illustrated in FIG. 3, the partition member 142 includes a partition member main body 151 and a seal member 152. The partition member main body 151 is formed of a metal, ceramics, or the like. Materials of the base member 26 and the partition member main body 151 are different. The base member 26 and the partition member main body 151 have different hardnesses. The Brinell hardness and the Vickers hardness may be made different by making the materials and hardnesses different, or the hardnesses may be made different according to the processing. The partition member main body 151 has an annular shape. The partition member main body 151 has a through hole 154 formed at a center in the radial direction. The through hole 154 penetrates the partition member main body 151 in the axial direction. The base member 26 to which a residual axial force is applied is required to have a higher hardness, higher durability, and the like than the partition member 142. In that case, “hardness of the base member 26>hardness of the partition member 142” may be made by making the materials or processing different, or the hardnesses may be made different by making “a total passage area of the base member 26<a total passage area of the partition member 142” using the same material.

The partition member main body 151 includes a partition plate part 161, an inner seat part 162, a valve seat part 163, an intermediate connection part 164, a disc-shaped part 165, an inner seat part 166, and a valve seat part 167.

The partition plate part 161 has a plate shape and is annular. The partition plate part 161 is fitted in the inner cylinder 3 of the cylinder. Then, the partition member main body 151 partitions the inside of the inner cylinder 3 into a side above the partition plate part 161 and a side below the partition plate part 161. A seal groove 171 is formed in the outer circumferential portion of the partition plate part 161. The seal groove 171 is formed at an intermediate position in an axial direction of the partition plate part 161. The seal groove 171 is recessed inward in a radial direction of the partition plate part 161 from an outer circumferential surface of the partition plate part 161. The seal groove 171 is formed on the partition plate part 161 over the entire circumference. The seal groove 171 has an annular shape.

The inner seat part 162 is provided at an inner circumferential edge portion of the partition plate part 161. The inner seat part 162 protrudes from the partition plate part 161 to one side in the axial direction thereof. The inner seat part 162 is formed on the partition plate part 161 over the entire circumference. The inner seat part 162 has an annular shape.

The valve seat part 163 is provided on an outer side of the inner seat part 162 in the radial direction of the partition plate part 161. A plurality of valve seat parts 163 are provided at regular intervals in a circumferential direction of the partition plate part 161. Adjacent valve seat parts 163 in the circumferential direction of partition plate part 161 are separated from each other. The valve seat parts 163 are all annular.

The intermediate connection part 164 is provided at the inner circumferential edge of the partition plate part 161. The intermediate connection part 164 protrudes from the partition plate part 161 to a side opposite to the inner seat part 162 in the axial direction. The intermediate connection part 164 is formed on the partition plate part 161 over the entire circumference. The intermediate connection part 164 has an annular shape.

The disc-shaped part 165 is provided on the opposite side of the intermediate connection part 164 from the partition plate part 161 in the axial direction. The disc-shaped part 165 extends from the intermediate connection part 164 outward in a radial direction thereof. The disc-shaped part 165 has a plate shape and is annular. An outer diameter of the disc-shaped part 165 is smaller than an outer diameter of the partition plate part 161.

The inner seat part 166 is provided at an inner circumferential edge portion of the disc-shaped part 165. The inner seat part 166 protrudes from the disc-shaped part 165 to a side opposite to the intermediate connection part 164 in the axial direction. The inner seat part 166 is formed on the disc-shaped part 165 over the entire circumference. The inner seat part 166 has an annular shape.

The valve seat part 167 is provided on an outer side of the inner seat part 166 in a radial direction of the disc-shaped part 165. The valve seat part 167 is formed on the disc-shaped part 165 over the entire circumference. The valve seat part 167 has an annular shape.

The through hole 154 has a larger diameter at an end portion on the inner seat part 166 side in the axial direction than at the remaining portion. The fitting shaft part 93 of the pin member 71 is fitted in a portion with a smaller diameter of the through hole 154.

The partition member main body 151 includes a passage hole 181 formed to penetrate the partition plate part 161, the intermediate connection part 164, and the disc-shaped part 165 in an axial direction of the partition member main body 151. A plurality of passage holes 181 are formed at intervals in a circumferential direction of the partition member main body 151 (only one is illustrated in FIG. 3 because it is a cross section).

The partition member main body 151 includes a passage groove 182 between the inner seat part 166 and the valve seat part 167 that is recessed to the disc-shaped part 165 side from an end surface on a side opposite to the disc-shaped part 165 in the axial direction. The passage groove 182 has an annular shape.

In the partition member main body 151, a portion between the inner seat part 162 and the plurality of valve seat parts 163 is a passage groove 183 that is recessed to the partition plate part 161 side from an end surface on a side opposite to the partition plate part 161 in the axial direction. The passage groove 183 includes a portion between the inner seat part 162 and the plurality of valve seat parts 163 in the radial direction of the partition plate part 161, and a portion between adjacent ones of the plurality of valve seat parts 163 in the circumferential direction of the partition plate part 161. The passage groove 183 opens to an outer side of the plurality of valve seat parts 163 in the radial direction of the partition plate part 161.

One ends of the passage holes 181 open to the passage groove 182 and the other ends thereof open to the passage groove 183. The plurality of passage holes 181, the passage groove 182, and the passage groove 183 constitute a first passage 184. The first passage 184 penetrates the partition member 142 in the axial direction.

The partition member main body 151 includes a passage hole 191 formed to penetrate the partition plate part 161 in the axial direction of the partition member main body 151. A plurality of passage holes 191 are formed at intervals in the circumferential direction of the partition member main body 151. The passage holes 191 are provided in the same number as the valve seat parts 163. One ends of all the passage holes 191 in the axial direction open to an inner side of the corresponding annular valve seat parts 163, respectively. The other ends of all the passage holes 191 in the axial direction open to an outer side of the intermediate connection part 164 in the radial direction of the partition plate part 161. The plurality of passage holes 191 constitute a first passage 194. The first passage 194 penetrates the partition member 142 in the axial direction.

The seal member 152 is an elastic seal member made of rubber or the like. Therefore, the base member 26 and the partition member 142 including the seal member 152 are formed of different materials. The base member 26 and the partition member 142 have different hardnesses. The seal member 152 is fitted in the seal groove 171 of the partition member main body 151. In the partition member 142, the partition plate part 161 of the partition member main body 151 and the seal member 152 are fitted in an inner circumferential portion of the inner cylinder 3 of the cylinder 2. Thereby, the seal member 152 seals a gap between the inner cylinder 3 and the partition member main body 151. Therefore, a partition part 197 formed of the partition plate part 161 and the seal member 152 partitions the inside of the inner cylinder 3 into a side above the partition part 197 and a side below the partition part 197 while sealing between them. Therefore, the partition member 142 formed of the partition member main body 151 and the seal member 152 partitions the inside of the inner cylinder 3 into a side above the partition plate part 161 and the seal member 152 and a side below the partition plate part 161 and the seal member 152 while sealing between them. The partition member 142 is directed such that the disc-shaped part 165 is positioned on the base member 26 side with respect to the partition plate part 161 in the axial direction of the pin member 71.

A portion of the base valve 25 between the partition part 197 and the base member 26 in the axial direction has a gap between itself and the inner cylinder 3 in a radial direction of the base valve 25. This gap communicates with the bottom chamber 112 between the bottom part 12 of the outer cylinder 4 and the base member 26 through a passage in the through hole 104 of the base member 26. Therefore, the outer circumferential chamber 175 on the inner circumferential side of the inner cylinder 3, on the outer circumferential side of the base valve 25, and between the partition part 197 and the base member 26 also serves as the reservoir chamber 6. In the base valve 25, the partition part 197 formed of the partition plate part 161 of the partition member 142 and the seal member 152 partitions the lower chamber 20 in the cylinder 2 and the reservoir chamber 6 while sealing between them. The partition member main body 151 partitions the inside of the inner cylinder 3 into the lower chamber 20 above the partition plate part 161 and the reservoir chamber 6 below the partition plate part 161.

As illustrated in FIG. 4, the plurality of discs 141, the plurality of discs 140, the pilot disc 139, the plurality of discs 138, the disc 137, the disc 136, the pilot case retainer 135, and the plurality of discs 132 are provided on the inner seat part 166 side in the axial direction of the partition member 142 in order from the partition member 142 side in the axial direction of the partition member 142. Also, the valve member 131 is provided on a side of the pilot case retainer 135 opposite to the disc 136 in the axial direction. The disc 127, the disc 126, and the pilot case 125 are provided on a side of the disc 132 and the valve member 131 opposite to the pilot case retainer 135 in the axial direction in order from a side of the disc 132 and the valve member 131.

The pilot case 125, the discs 126, 127, 132, 136 to 138, 140, and 141, and the pilot case retainer 135 are all made of a metal. All the discs 126, 127, 132, 136 to 138, 140, and 141 have a bored circular flat plate shape with a constant thickness. The pilot case 125, the valve member 131, the pilot case retainer 135, and the pilot disc 139 are all annular.

The pilot case 125 has a bottomed cylindrical shape. A through hole 211 is formed at a center of the pilot case 125 in the radial direction. The through hole 211 penetrates the pilot case 125 in an axial direction thereof. The through hole 211 has a larger diameter at an end portion on a side opposite to the partition member 142 in the axial direction than at the remaining portion. The fitting shaft part 93 of the pin member 71 is fitted in a portion with a smaller diameter of the through hole 211.

The pilot case 125 has a bottom part 221, an inner cylindrical part 222, an outer cylindrical part 223, an inner seat part 224, and a valve seat part 225.

The bottom part 221 has a bored disc shape. The bottom part 221 includes a passage hole 228 formed on a radially outer side of the through hole 211 to penetrate the bottom part 221 in an axial direction of the bottom part 221.

The inner cylindrical part 222 has an annular shape and protrudes from an inner circumferential edge portion of the bottom part 221 to the partition member 142 side in the axial direction of the bottom part 221.

The outer cylindrical part 223 has a cylindrical shape and protrudes from an outer circumferential edge portion of the bottom part 221 to the same side as the inner cylindrical part 222 in the axial direction of the bottom part 221. A height of the outer cylindrical part 223 from the bottom part 221 in the axial direction of the bottom part 221 is larger than that of the inner cylindrical part 222. The outer cylindrical part 223 has a small inner diameter portion 231 and a large inner diameter portion 232 at an inner circumferential portion. An inner diameter of the small inner diameter portion 231 is smaller than an inner diameter of the large inner diameter portion 232. The small inner diameter portion 231 is formed on the bottom part 221 side in an axial direction of the outer cylindrical part 223. The large inner diameter portion 232 is formed on a side opposite to the bottom part 221 with respect to the small inner diameter portion 231 in the axial direction of the outer cylindrical part 223.

The inner seat part 224 has an annular shape and protrudes from the inner circumferential edge portion of the bottom part 221 to a side opposite to the inner cylindrical part 222 in the axial direction.

The valve seat part 225 has an annular shape with a larger diameter than the inner seat part 224. The valve seat part 225 is on an outer side of the inner seat part 224 in a radial direction of the bottom part 221. The valve seat part 225 protrudes from the bottom part 221 to the same side as the inner seat part 224 in the axial direction of the bottom part 221.

The passage hole 228 is disposed on an outer side of the valve seat part 225 in the radial direction of the bottom part 221. A passage 229 in the passage hole 228 is in constant communication with the reservoir chamber 6. The passage hole 228 is formed to partially overlap the outer cylindrical part 223 in the radial direction of the bottom part 221.

The plurality of (specifically, two) discs 141 have the same outer diameter. An outer diameter of the discs 141 is larger than an outer diameter of the inner seat part 166 of the partition member 142 and smaller than an inner diameter of the valve seat part 167 of the partition member 142. Of the discs 141, the disc 141 on the partition member 142 side in the axial direction is in contact with the inner seat part 166 of the partition member 142. A notch 241 is formed in this disc 141. The notch 241 opens at an inner circumferential portion of the disc 141 and extends to an outer side of the inner seat part 166 in a radial direction thereof. The inside of the notch 241 of the disc 141 is an orifice 242. The orifice 242 is in constant communication with the first passage 184 of the partition member 142 and an intermediate chamber 243 in the groove part 91 of the pin member 71.

The plurality of (specifically, two) discs 140 have the same outer diameter. An outer diameter of the discs 140 is larger than the outer diameter of the discs 141 and larger than an outer diameter of the valve seat part 167 of the partition member 142. Of the discs 140, the disc 140 closest to the partition member 142 side in the axial direction is in contact with the valve seat part 167 of the partition member 142 and the disc 141. The plurality of discs 140 open and close an opening of the first passage 184 formed in the partition member 142 by being separated from and coming into contact with the valve seat part 167. Of the plurality of discs 140, the disc 140 closest to the partition member 142 side in the axial direction includes a fixed orifice 244 formed to allow the first passage 184 to communicate with the reservoir chamber 6 even when the disc 140 is in contact with the valve seat part 167.

The pilot disc 139 is formed of a disc 245 and a seal member 246.

The disc 245 is made of a metal and has a bored circular flat plate shape. The fitting shaft part 93 of the pin member 71 is fitted inside the disc 245. Of the plurality of discs 140, the disc 140 on a side most opposite to the partition member 142 in the axial direction is in contact with the disc 245 of the pilot disc 139.

The seal member 246 is made of rubber and is adhered to a side of the disc 245 opposite to the partition member 142 in the axial direction. The seal member 246 is fixed to the outer circumferential side of the disc 245 and has an annular shape. The seal member 246 is fitted in a liquid-tight manner to the large inner diameter portion 232 of the outer cylindrical part 223 of the pilot case 125 over the entire circumference. The seal member 246 is slidable in the axial direction with respect to the large inner diameter portion 232 of the outer cylindrical part 223. The seal member 246 constantly seals a gap between the pilot disc 139 and the outer cylindrical part 223.

The plurality of discs 140 and the pilot disc 139 constitute a damping valve 250. When the damping valve 250 is separated from the valve seat part 167 of the partition member 142 and opens, the working fluid L passing through the first passage 184 from the lower chamber 20 illustrated in FIG. 3 is allowed to flow into the reservoir chamber 6 through between the partition member 142 and the outer cylindrical part 223 of the pilot case 125 illustrated in FIG. 4. At that time, the damping valve 250 suppresses a flow of the working fluid L between itself and the valve seat part 167. The valve seat part 167 and the damping valve 250 constitute a first damping force generation mechanism 251. The first passage 184 and a passage between the damping valve 250 and the valve seat part 167 form a flow path 252 that allows communication between the lower chamber 20 illustrated in FIG. 3 and the reservoir chamber 6 illustrated in FIG. 4.

The first damping force generation mechanism 251 is provided in the flow path 252. The first damping force generation mechanism 251 opens and closes the flow path 252 to generate a damping force. As illustrated in FIG. 3, the first damping force generation mechanism 251 is disposed on the reservoir chamber 6 side which is one end side of the partition part 197 of the partition member 142 in the axial direction among the lower chamber 20 and the reservoir chamber 6. Thereby, the flow path 252 illustrated in FIG. 4 serves as a flow path through which the working fluid L as a working fluid moves from the lower chamber 20 toward the reservoir chamber 6 due to movement of the piston 18 illustrated in FIG. 1 to the lower chamber 20 side. That is, the flow path 252 illustrated in FIG. 4 serves as a flow path through which the working fluid L moves from the lower chamber 20, illustrated in FIG. 3, on an upstream side to the reservoir chamber 6 on a downstream side during the compression stroke. The first damping force generation mechanism 251 is a compression-side damping force generation mechanism that generates a damping force by suppressing a flow of the working fluid L from the flow path 252 illustrated in FIG. 4 to the reservoir chamber 6 that occurs during the compression stroke. The fixed orifice 244 formed in the disc 140 of the damping valve 250 also constitutes the first damping force generation mechanism 251.

The plurality of discs 138 have the same outer diameter. An outer diameter of the discs 138 is smaller than a minimum inner diameter of the seal member 246 of the pilot disc 139 and smaller than the outer diameter of the inner seat part 166 of the partition member 142. Of the plurality of discs 138, the disc 138 closest to the partition member 142 side in the axial direction is in contact with the disc 245 of the pilot disc 139.

An outer diameter of the disc 137 is larger than the outer diameter of the discs 138.

An outer diameter of the disc 136 is larger than the outer diameter of the disc 137. A notch 261 is formed in the disc 136. The notch 261 opens at an inner circumferential portion of the disc 136 and extends to an outer side of the disc 137 in a radial direction thereof. The inside of the notch 261 is an orifice 262. The orifice 262 is in constant communication with the intermediate chamber 243 in the groove part 91 of the pin member 71.

The pilot case retainer 135 has a disc shape. The pilot case retainer 135 has a through hole 271 formed at a center in a radial direction thereof to penetrate the pilot case retainer 135 in the axial direction. The through hole 271 has a larger diameter at an end portion on the partition member 142 side in the axial direction than at the remaining portion. The fitting shaft part 93 of the pin member 71 is fitted in a portion with a smaller diameter of the through hole 271.

The pilot case retainer 135 includes a base plate part 281, a protruding part 282, a protruding part 283, and a seat part 284.

The base plate part 281 has a bored disc shape.

The protruding part 282 has an annular shape. The protruding part 282 protrudes from an inner circumferential edge portion of the base plate part 281 to the partition member 142 side in an axial direction of the base plate part 281. An outer diameter of the protruding part 282 is equal to the outer diameter of the disc 137. The protruding part 282 of the pilot case retainer 135 is in contact with the disc 136.

The protruding part 283 has an annular shape. The protruding part 283 protrudes from the inner circumferential edge portion of the base plate part 281 to a side opposite to the protruding part 282 in the axial direction of the base plate part 281. The protruding part 283 includes a groove part 287 formed to extend from an outer circumferential surface to a radial intermediate position in a radial direction thereof.

The seat part 284 has an annular shape. The seat part 284 is provided on an outer side of the protruding part 283 in a radial direction of the base plate part 281. The seat part 284 protrudes from the base plate part 281 to the same side as the protruding part 283 in the axial direction of the base plate part 281. The seat part 284 has a plurality of notch parts 288 formed at a distal end portion on the protruding side to penetrate the distal end portion in a radial direction of the seat part 284 at intervals in a circumferential direction of the seat part 284. Therefore, the distal end portion on the protruding side of the seat part 284 is intermittently cut out in the circumferential direction of the seat part 284. In the axial direction of the base plate part 281, a protruding height of the seat part 284 from the base plate part 281 is larger than a protruding height of the protruding part 283 from the base plate part 281.

The plurality of discs 132 have the same outer diameter. An outer diameter of the discs 132 is smaller than an outer diameter of the protruding part 283 of the pilot case retainer 135. Of the plurality of discs 132, the disc 132 on the partition member 142 side in an axial direction thereof is in contact with the protruding part 283.

The valve member 131 is formed of a valve disc 291 and an elastic seal member 292. The valve member 131 is disposed between the small inner diameter portion 231 of the outer cylindrical part 223 of the pilot case 125 and the discs 132 in the radial direction.

The valve disc 291 is made of a metal. The valve disc 291 has a bored circular flat plate shape with a constant thickness. The fitting shaft part 93 of the pin member 71 and the plurality of discs 132 are inserted through an inner circumferential side of the valve disc 291. The valve disc 291 has an inner diameter that allows the plurality of discs 132 to be disposed inside with a gap in the radial direction. The valve disc 291 has a smaller thickness than a total thickness of the plurality of (specifically, two) discs 132. The valve disc 291 is elastically deformable, that is, bendable.

The elastic seal member 292 is made of rubber and has an annular shape. The elastic seal member 292 is adhered to an outer circumferential side of the valve disc 291. The elastic seal member 292 is provided integrally with the valve disc 291 by being baked into the valve disc 291.

The elastic seal member 292 includes a seal part 295 and a contact part 296.

The seal part 295 has an annular shape and is fixed to the outer circumferential side of the valve disc 291 over the entire circumference. The seal part 295 protrudes to the partition member 142 side in the axial direction of the valve member 131.

The contact part 296 has an annular shape and protrudes from the valve disc 291 to a side opposite to the seal part 295 in the axial direction of the valve member 131. The contact part 296 is welded to the outer circumferential side of the valve disc 291 over the entire circumference. The contact part 296 is connected to the seal part 295 at the outer circumferential side of the valve disc 291. An outer diameter of the contact part 296 decreases and an inner diameter thereof increases with distance away from the valve disc 291 in the axial direction. The contact part 296 has a plurality of notch parts 297 formed at a distal end portion on the protruding side to penetrate the distal end portion in a radial direction of the contact part 296 at intervals in a circumferential direction of the contact part 296. Therefore, the distal end portion of the contact part 296 on the protruding side is intermittently cut out in the circumferential direction of the contact part 296.

As described above, there is a radial gap between the valve member 131 and the plurality of discs 132. Then, the valve member 131 is press-fitted into the small inner diameter portion 231 of the pilot case 125 at the seal part 295 thereof. Due to this press fitting, the valve member 131 is centered to be disposed coaxially with the pilot case 125, the plurality of discs 132, and the pin member 71. At that time, the seal part 295 of the valve member 131 is in contact with the small inner diameter portion 231 over the entire circumference with a fastening allowance in the radial direction. In other words, the seal part 295 of the valve member 131 is in close contact with the small inner diameter portion 231 of the pilot case 125 over the entire circumference. Thereby, the seal part 295 of the valve member 131 is fitted in a liquid-tight manner to the outer cylindrical part 223 of the pilot case 125 over the entire circumference.

The seal part 295 is slidable in the axial direction of the outer cylindrical part 223 with respect to the small inner diameter portion 231. At that time, the seal part 295 slides in the axial direction with respect to the small inner diameter portion 231 while maintaining a state of being in close contact with the small inner diameter portion 231 over the entire circumference. Thereby, the seal part 295 of the elastic seal member 292 constantly seals a gap between the valve member 131 and the small inner diameter portion 231. The seal part 295 is on a radially outer side of the seat part 284 of the pilot case retainer 135. The valve disc 291 of the valve member 131 is in contact with the seat part 284.

An outer diameter of the disc 127 is slightly larger than an inner diameter of the valve member 131, that is, an inner diameter of the valve disc 291. An inner circumferential side of the disc 127 is in contact with the disc 132, and an outer circumferential side thereof is in contact with the valve disc 291.

An outer diameter of the disc 126 is larger than the outer diameter of the disc 127 and is equal to an outer diameter of a distal end surface of the inner cylindrical part 222 of the pilot case 125. The disc 126 is in contact with the disc 127 and the inner cylindrical part 222 of the pilot case 125.

An inner circumferential side of the valve disc 291 of the valve member 131 is disposed between the protruding part 283 and the disc 127 in the axial direction and is supported in contact with the disc 127. The inner circumferential side of the valve disc 291 of the valve member 131 is movable in a range of an entire axial length of the plurality of (specifically, two) discs 132 between the protruding part 283 and the disc 127. The inner circumferential side of the valve disc 291 of the valve member 131 is supported by the disc 127 on only one side without being clamped from both sides. In the valve member 131, a portion of the valve disc 291 on a radially outer side of the disc 127 is supported by the seat part 284 on only one side without being clamped from both sides. Therefore, the valve member 131 has a simple support structure in which one side of the valve disc 291 is supported by the disc 127 and the other side of the valve disc 291 is supported by the seat part 284. In other words, the valve disc 291 is not clamped in the axial direction. The valve member 131 has an annular shape as a whole and is elastically deformable, that is, bendable.

The contact part 296 of the valve member 131 is in contact with the bottom part 221 of the pilot case 125. The bottom part 221 of the pilot case 125 suppresses movement of the valve member 131 to a side opposite to the seat part 284 in an axial direction of the pilot case 125.

The seat part 284 of the pilot case retainer 135 supports the valve disc 291 of the valve member 131 from one side in the axial direction. The disc 127 supports the inner circumferential side of the valve disc 291 with respect to the seat part 284 from the other side in the axial direction. A shortest distance in the axial direction between the seat part 284 and the disc 127 is slightly smaller than a thickness of the valve disc 291 in the axial direction. Therefore, the valve disc 291 presses against both the seat part 284 and the disc 127 with its own elastic force in a state of being elastically deformed into a slightly tapered shape. That is, the valve disc 291 is seated on the disc 127 by its own elastic force. The valve disc 291 can be separated from the disc 127 by a pressure applied to the valve member 131.

The valve member 131 is provided inside the pilot case 125 and partitions the inside of the pilot case 125 into a back pressure chamber 301 and a bottom side chamber 302.

The back pressure chamber 301 is formed by being surrounded by the outer cylindrical part 223 of the pilot case 125, the pilot disc 139, the discs 127, 132, and 136 to 138, the pilot case retainer 135, and the valve member 131. The back pressure chamber 301 is between the pilot disc 139 and the valve member 131 in the axial direction of the pilot case 125. In other words, the back pressure chamber 301 is on a side opposite to the bottom part 221 with respect to the valve member 131 in the axial direction of the pilot case 125. The back pressure chamber 301 applies a pressure to the plurality of discs 140 in a direction of the partition member 142 via the pilot disc 139. In other words, the back pressure chamber 301 applies an internal pressure to the damping valve 250 in a valve closing direction in which the damping valve 250 is seated on the valve seat part 167. The back pressure chamber 301 also constitutes the first damping force generation mechanism 251.

The bottom side chamber 302 is formed by being surrounded by the bottom part 221 of the pilot case 125, the inner cylindrical part 222, and the outer cylindrical part 223, the discs 126 and 127, and the valve member 131.

The bottom side chamber 302 is between the valve member 131 and the bottom part 221 in the axial direction of the pilot case 125. In other words, the bottom side chamber 302 is on the bottom part 221 side with respect to the valve member 131 in the axial direction of the pilot case 125. In the bottom side chamber 302, a chamber outside the contact part 296 and a chamber inside the contact part 296 in the radial direction are in constant communication with each other due to passages in the notch parts 297.

The back pressure chamber 301 is in constant communication with the lower chamber 20 illustrated in FIG. 3 via the orifice 262 of the disc 136, the intermediate chamber 243 of the pin member 71, the orifice 242 of the disc 141, and the first passage 184 of the partition member 142. The first damping force generation mechanism 251 controls opening of the damping valve 250 using the pressure in the back pressure chamber 301 illustrated in FIG. 4 into which the working fluid L is introduced from the lower chamber 20.

When the valve disc 291 of the valve member 131 is separated from the disc 127, the bottom side chamber 302 communicates with the back pressure chamber 301 through a passage between the valve disc 291 and the disc 127. The bottom side chamber 302 constantly communicates with the reservoir chamber 6 through the passage 229 of the pilot case 125.

One disc 124, the plurality of (specifically, five) discs 123, one disc 122, and one disc 121 are provided on a side of the inner seat part 224 and valve seat part 225 in the axial direction of the pilot case 125 in order from the pilot case 125 side in the axial direction of the pilot case 125. The disc 121 is in contact with the inner cylindrical part 102 of the base member 26. The discs 121 to 124 are all made of a metal. All the discs 121 to 124 have a bored circular flat plate shape with a constant thickness.

An outer diameter of the disc 124 is larger than an outer diameter of the inner seat part 224 of the pilot case 125 and smaller than an inner diameter of the valve seat part 225. The disc 124 is in contact with the inner seat part 224. A notch 311 is formed in the disc 124. The notch 311 opens at an inner circumferential portion of the disc 124 and extends to an outer side of the inner seat part 224 in a radial direction thereof. The inside of the notch 311 is an orifice 312. The orifice 312 is in constant communication with the intermediate chamber 243 in the groove part 91 of the pin member 71.

The plurality of (specifically, five) discs 123 have the same outer diameter. An outer diameter of the discs 123 is larger than an outer diameter of the disc 124 and larger than an outer diameter of the valve seat part 225 of the pilot case 125. Of the plurality of discs 123, the disc 123 on the disc 124 side in the axial direction can be seated on the valve seat part 225. The plurality of discs 123 constitute a disc valve 315. The disc valve 315 can be separated from and seated on the valve seat part 225.

An outer diameter of the disc 122 is smaller than an outer diameter of the disc valve 315.

An outer diameter of the disc 121 is larger than the outer diameter of the disc 122 and smaller than the outer diameter of the disc valve 315.

A chamber 325 is formed by being surrounded by the bottom part 221 of the pilot case 125, the inner seat part 224, the valve seat part 225, the disc 124, and the disc valve 315. The chamber 325 is in constant communication with the intermediate chamber 243 of the pin member 71 through the orifice 312 of the disc 124. The chamber 325 is in constant communication with the back pressure chamber 301 via the orifice 312 of the disc 124, the intermediate chamber 243 of the pin member 71, and the orifice 262 of the disc 136. The chamber 325 is in constant communication with the lower chamber 20 illustrated in FIG. 3 via the orifice 312 of the disc 124, the intermediate chamber 243 of the pin member 71, the orifice 242 of the disc 141, and the first passage 184.

When the disc valve 315 illustrated in FIG. 4 separates from the valve seat part 225, the lower chamber 20 and the reservoir chamber 6 illustrated in FIG. 3 communicate with each other via the first passage 184, the orifice 242 of the disc 141, the intermediate chamber 243 of the pin member 71, the orifice 312 of the disc 124, and the chamber 325, and a passage between the disc valve 315 and the valve seat part 225. At that time, the disc valve 315 illustrated in FIG. 4 suppresses a flow of the working fluid L between itself and the valve seat part 225.

The first passage 184, the orifice 242 of the disc 141, the intermediate chamber 243 of the pin member 71, the orifice 312 of the disc 124, and the chamber 325, and the passage between the disc valve 315 and the valve seat part 225 constitute a flow path 331 (first flow path) that allows communication between the lower chamber 20 and the reservoir chamber 6 illustrated in FIG. 3. Therefore, the partition member 142 in which the first passage 184 is formed has a part of the flow path 331. As illustrated in FIG. 4, the flow path 331 includes the orifice 262 of the disc 136 and the back pressure chamber 301. Also, the flow path 331 includes the passage 229 of the pilot case 125, the bottom side chamber 302, and the passage between the valve disc 291 of the valve member 131 and the disc 127. The flow path 331 is not provided in the base member 26.

The disc valve 315 and the valve seat part 225 constitute a second damping force generation mechanism 332. The second damping force generation mechanism 332 allows the working fluid L to flow from the lower chamber 20 illustrated in FIG. 3 to the reservoir chamber 6 through the flow path 331 illustrated in FIG. 4 when the disc valve 315 is separated from the valve seat part 225 during the compression stroke. At that time, the second damping force generation mechanism 332 generates a damping force by suppressing a flow of the working fluid L between the lower chamber 20 and the reservoir chamber 6 illustrated in FIG. 3.

The pilot case 125, the discs 126, 127, 132, and 136 to 138, the valve member 131, the pilot case retainer 135, and the pilot disc 139 illustrated in FIG. 4 constitute the frequency sensitive part 335. The frequency sensitive part 335 includes the back pressure chamber 301 and the bottom side chamber 302. Both the back pressure chamber 301 and the bottom side chamber 302 are variable in capacity. Capacities of both the back pressure chamber 301 and the bottom side chamber 302 change due to deformation of the valve member 131. The frequency sensitive part 335 makes a damping force of the base valve 25 variable in accordance with a frequency of axial movement of the piston 18 (hereinafter referred to as a piston frequency) illustrated in FIG. 1. As illustrated in FIG. 3, the frequency sensitive part 335 is provided on the bottom part 12 side of the partition member 142 in the axial direction of the cylinder 2. The frequency sensitive part 335 is provided on the bottom part 12 side with respect to the partition part 197 in the axial direction of the cylinder 2. The base member 26 is provided on the bottom part 12 side with respect to the frequency sensitive part 335 in the axial direction of the cylinder 2. In the frequency sensitive part 335, the working fluid L is supplied to the back pressure chamber 301 and the bottom side chamber 302. Therefore, the working fluid L is supplied to the frequency sensitive part 335 through the flow path 331. The base valve 25 includes the frequency sensitive part 335.

During the compression stroke of the shock absorber 1, the base valve 25 is configured such that the working fluid L from the lower chamber 20 illustrated in FIG. 3 is introduced into the back pressure chamber 301 via the first passage 184, the orifice 242 of the disc 141, the intermediate chamber 243 of the pin member 71, and the orifice 262 of the disc 136 illustrated in FIG. 4. Then, the valve disc 291 of the valve member 131 deforms into a tapered shape so that an outer circumferential side thereof is separated from the seat part 284 in an axial direction of the seat part 284 using a contact point with the disc 127 in contact as a fulcrum. At that time, the valve disc 291 compressively deforms the contact part 296 of the elastic seal member 292 that is in contact with the bottom part 221 of the pilot case 125. A volume of the back pressure chamber 301 increases due to the deformation of the valve disc 291. Here, at the time of the deformation of the valve disc 291, a volume of the bottom side chamber 302 decreases. At that time, the working fluid L in the bottom side chamber 302 flows into the reservoir chamber 6 through the passage 229 of the pilot case 125.

In the flow path 331, the first passage 184, the orifice 242 of the disc 141, the intermediate chamber 243 of the pin member 71, the orifice 262 of the disc 136, and the back pressure chamber 301 are in constant communication with the lower chamber 20 illustrated in FIG. 3. In the flow path 331 illustrated in FIG. 4, the passage 229 of the pilot case 125 and the bottom side chamber 302 are in constant communication with the reservoir chamber 6. The flow path 331 is a passage through which the working fluid L moves from the lower chamber 20, illustrated in FIG. 3, on an upstream side toward the reservoir chamber 6 on a downstream side during the compression stroke. The frequency sensitive part 335 is provided in the flow path 331.

As illustrated in FIG. 4, the inner circumferential side of the valve disc 291 of the valve member 131 is movable in the axial direction between the protruding part 283 of the pilot case retainer 135 and the disc 127. In a state in which the inner circumferential side of the valve disc 291 is in contact with the disc 127 over the entire circumference, the valve member 131 blocks a flow of the working fluid L between the back pressure chamber 301 and the bottom side chamber 302. Also, in a state in which the inner circumferential side of the valve disc 291 is separated from the disc 127, the valve member 131 allows a flow of the working fluid L between the bottom side chamber 302 and the back pressure chamber 301. The inner circumferential side of the valve disc 291 and the disc 127 constitute a check valve 338. The check valve 338 is provided in the flow path 331.

The check valve 338 restricts a flow of the working fluid L from the back pressure chamber 301 to the bottom side chamber 302 through the flow path 33 while allowing a flow of the working fluid L from the bottom side chamber 302 to the back pressure chamber 301 through the flow path 331. The check valve 338 blocks communication between the lower chamber 20 and the reservoir chamber 6 through the flow path 331 during the compression stroke in which a pressure in the lower chamber 20 illustrated in FIG. 3 is higher than a pressure in the reservoir chamber 6. The check valve 338 allows communication between the reservoir chamber 6 and the lower chamber 20 through the flow path 331 during the extension stroke in which a pressure in the reservoir chamber 6 is higher than a pressure in the lower chamber 20. In this way, the flow path 331 allows communication between the lower chamber 20 and the reservoir chamber 6 when the check valve 338 opens.

The plurality of or one valve disc 145, the plurality of (specifically, two) discs 146, one spring disc 147, and one restriction disc 148 are provided on a side of the inner seat part 162 and the valve seat part 163 in the axial direction of the partition member 142 in order from the partition member 142 side in the axial direction of the partition member 142. The restriction disc 148 is in contact with the nut member 72. The valve disc 145, the discs 146, the spring disc 147, and the restriction disc 148 are all made of a metal. Both the valve disc 145 and the discs 146 have a bored circular flat plate shape with a constant thickness. The spring disc 147 and the restriction disc 148 have an annular shape. The shaft part 81 of the pin member 71 is fitted to the inside of the valve disc 145, the discs 146, the spring disc 147, and the restriction disc 148.

The valve disc 145 is in contact with the inner seat part 162 and the valve seat part 163 of the partition member 142. The valve disc 145 opens and closes an opening of the first passage 194 formed in the partition member 142 by being separated from and coming into contact with the valve seat part 163. The valve disc 145 can open the first passage 194 to the lower chamber 20 by being separated from the valve seat part 163. The valve disc 145 includes a fixed orifice 341 formed to allow the first passage 194 to communicate with the lower chamber 20 even when the valve disc 145 is in contact with the valve seat part 163 (even without providing the fixed orifice 341 on the valve disc 145, even when coining is provided on the valve seat part 163, the fixed orifice 341 is formed in a state in which the valve disc 145 and the valve seat part 163 are in contact with each other). A through hole 342 penetrating the valve disc 145 in the axial direction is formed in the valve disc 145. The through hole 342 is aligned with the passage groove 183 in radial position of the partition member 142. The through hole 342 increases an area of a passage through which the first passage 184 communicates with the lower chamber 20.

The plurality of (specifically, two) discs 146 have the same outer diameter. The entire discs 146 have an outer diameter that is in contact with an inner side of the through hole 342 in a radial direction of the valve disc 145.

The spring disc 147 includes a base plate part 351 and a plurality of spring plate parts 352.

The base plate part 351 has a bored circular flat plate shape with a constant thickness. The shaft part 81 of the pin member 71 is fitted to an inner circumferential portion of the base plate part 351.

The plurality of spring plate parts 352 extend outward in a radial direction of the base plate part 351 from positions equidistant from each other in a circumferential direction of the base plate part 351. The spring plate part 352 is inclined with respect to the base plate part 351 so that it becomes further away from the base plate part 351 in an axial direction of the base plate part 351 toward an extension distal end side.

The spring disc 147 is directed such that the spring plate part 352 extends from the base plate part 351 to the valve disc 145 side in the axial direction of the base plate part 351. In the spring disc 147, the plurality of spring plate parts 352 are in contact with the valve disc 145. The spring disc 147 brings the valve disc 145 into contact with the valve seat part 163 of the partition member 142. The valve disc 145 is seated on the valve seat part 163 to close the first passage 194 by a biasing force of the spring disc 147.

When the valve disc 145 is separated from the valve seat part 163 against the biasing force of the spring disc 147, the valve disc 145 allows the working fluid L from the first passage 194 to flow into the lower chamber 20. At this time, the valve disc 145 suppresses a flow of the working fluid L between itself and the valve seat part 163. The valve disc 145, the discs 146, the spring disc 147, and the valve seat part 163 constitute an extension-side first damping force generation mechanism 355. A valve opening pressure of the valve disc 145 is set by adjusting a pre-load of the spring disc 147 and the number of discs 146.

The first passage 194 and a passage between the valve disc 145 and the valve seat part 163 form a flow path 356 that allows communication between the reservoir chamber 6 and the lower chamber 20. The first damping force generation mechanism 355 is provided in the flow path 356. The first damping force generation mechanism 355 opens and closes the flow path 356 to generate a damping force. The first damping force generation mechanism 355 is disposed on the lower chamber 20 side which is on a side of the partition member 142 opposite to the reservoir chamber 6 in the axial direction. Thereby, the flow path 356 is a flow path through which the working fluid L moves from the reservoir chamber 6 toward the lower chamber 20 due to movement of the piston 18 illustrated in FIG. 1 to the upper chamber 19 side. That is, the flow path 356 illustrated in FIG. 3 is a flow path through which the working fluid L moves from the reservoir chamber 6 on an upstream side toward the lower chamber 20 on a downstream side in the extension stroke. The first damping force generation mechanism 355 serves as an extension-side damping force generation mechanism that generates a damping force by suppressing a flow of the working fluid L from the flow path 356 to the lower chamber 20 that occurs during the extension stroke. The fixed orifice 341 also constitutes the first damping force generation mechanism 355.

The restriction disc 148 has a disc shape and includes a base plate part 361 and an outer circumferential plate part 362.

The base plate part 361 has a bored circular flat plate shape with a constant thickness. The shaft part 81 of the pin member 71 is fitted to an inner circumferential portion of the base plate part 361. A through hole 363 penetrating the base plate part 361 in the axial direction is formed in the base plate part 361. The through hole 363 is aligned with the first passage 184 in radial position of the partition member 142. The through hole 363 increases an area of a passage through which the first passage 184 communicates with the lower chamber 20.

The outer circumferential plate part 362 has a circular shape and is on an outer side of the base plate part 361 in the radial direction. The outer circumferential plate part 362 is slightly offset from the base plate part 361 in an axial direction of the base plate part 361. The restriction disc 148 is directed such that the outer circumferential plate part 362 is positioned on the valve disc 145 side with respect to the base plate part 361 in the axial direction of the base plate part 361. The restriction disc 148 suppresses deformation of the valve disc 145 in an opening direction beyond a specified limit by the outer circumferential plate part 362 coming into contact with the valve disc 145 when the valve disc 145 is deformed in the opening direction.

On the pin member 71, the base member 26, the disc 121, the disc 122, the plurality of discs 123, the disc 124, the pilot case 125, the disc 126, the disc 127, and the plurality of discs 132 are stacked in that order on the head part 82 with the shaft part 81 inserted through the inside of them.

Also, from this state, the valve member 131 is stacked on the disc 127 with the shaft part 81 and the plurality of discs 132 inserted through the inside. At this time, as illustrated in FIG. 4, the elastic seal member 292 of the valve member 131 is fitted into the small inner diameter portion 231 of the pilot case 125.

Further, from this state, on the pin member 71, the pilot case retainer 135, the disc 136, the disc 137, the plurality of discs 138, and the pilot disc 139 are stacked in that order on the disc 132 and the valve member 131 with the shaft part 81 inserted through the inside of them as illustrated in FIG. 3. At this time, as illustrated in FIG. 4, the seal member 246 of the pilot disc 139 is fitted into the large inner diameter portion 232 of the pilot case 125.

Further, from this state, on the pin member 71, the plurality of discs 140, the plurality of discs 141, the partition member 142, the valve disc 145, the plurality of discs 146, the spring disc 147, and the restriction disc 148 are stacked in that order on the pilot disc 139 with the shaft part 81 inserted through the inside of them as illustrated in FIG. 3.

With the parts from the base member 26 to the restriction disc 148 disposed on the pin member 71 as described above, the nut member 72 is screwed onto the screw part 92 of the shaft part 81 that protrudes from the restriction disc 148. Thereby, the parts from the base member 26 to the restriction disc 148, except for the valve member 131, are clamped in the axial direction by being sandwiched by the head part 82 of the pin member 71 and the nut member 72 at their inner circumferential side or in their entirety. Thereby, the partition member 142, the frequency sensitive part 335, and the base member 26 are fixed to the pin member 71 that penetrates through the partition member 142, the frequency sensitive part 335, and the base member 26. However, at that time, in the frequency sensitive part 335, the inner circumferential side of the valve member 131 is not clamped in the axial direction. In this state, in the valve member 131, the valve disc 291 comes into contact with the seat part 284 of the pilot case retainer 135 and the disc 127, and the contact part 296 of the elastic seal member 292 comes into contact with the bottom part 221 of the pilot case 125 as illustrated in FIG. 4.

Further, as indicated by the two-dot chain line in FIG. 1, an electronic control valve 371 is provided between the upper chamber 19 and the reservoir chamber 6 to control a flow rate of the working fluid L therebetween on the basis of an electrical signal.

Next, main operations of the base valve 25 of the shock absorber 1 will be described.

### [Compression Stroke]

“Compression Stroke in which Piston Frequency is Equal to or Higher than Predetermined Value”

In the compression stroke, the working fluid L is introduced from the lower chamber 20 into the back pressure chamber 301 via the first passage 184, the orifice 242 of the disc 141, the intermediate chamber 243 of the pin member 71, and the orifice 262 of the disc 136 in the flow path 331. Then, in the valve member 131 that has been in contact with the seat part 284, the disc 127, and the bottom part 221 of the pilot case 125, the valve disc 291 thereof deforms into a tapered shape in a direction in which the outer circumferential side thereof is separated from the seat part 284 using a contact point with the disc 127 as a fulcrum. At that time, the valve member 131 discharges the working fluid L from the bottom side chamber 302 to the reservoir chamber 6 through the passage 229.

Here, in a high-frequency compression stroke in which a piston frequency is equal to or higher than a predetermined value, a stroke of the piston 18 is small. Therefore, an amount of the working fluid L introduced from the lower chamber 20 into the back pressure chamber 301 via the first passage 184, the orifice 242, the intermediate chamber 243, and the orifice 262 is small. Therefore, the valve member 131 deforms as described above, but does not deform to near the limit. As a result, although the working fluid L is introduced from the lower chamber 20 into the back pressure chamber 301, the valve member 131 of the frequency sensitive part 335 is deformed as described above each time the compression stroke occurs, thereby suppressing an increase in pressure of the back pressure chamber 301.

During the high-frequency compression stroke in which the piston frequency is equal to or higher than the predetermined value, when a moving speed of the piston 18 (hereinafter referred to as a piston speed) is lower than a first predetermined value, the working fluid L from the lower chamber 20 flows into the reservoir chamber 6 through the fixed orifice 244 of the first damping force generation mechanism 251 in the flow path 252. Therefore, a damping force having orifice characteristics (in which the damping force is substantially proportional to the square of the piston speed) is generated. Therefore, the damping force characteristics with respect to the piston speed when the piston speed is lower than the first predetermined value are such that an increasing rate of the damping force with respect to an increase in the piston speed is relatively high.

In the high-frequency compression stroke in which the piston frequency is equal to or higher than the predetermined value, since an increase in pressure in the back pressure chamber 301 is suppressed as described above, the damping valve 250 of the first damping force generation mechanism 251 is easily opened. Therefore, when the piston speed is equal to or higher than the first predetermined value, the working fluid L from the lower chamber 20 opens the damping valve 250 of the first damping force generation mechanism 251 in the flow path 252 and flows into the reservoir chamber 6 through a gap between the damping valve 250 and the valve seat part 167. That is, the working fluid L from the lower chamber 20 flows into the reservoir chamber 6 through the flow path 252. Therefore, a damping force having valve characteristics (in which the damping force is substantially proportional to the piston speed) is generated. Therefore, the damping force characteristics with respect to the piston speed when the piston speed is equal to or higher than the first predetermined value are such that an increasing rate of the damping force with respect to an increase in the piston speed is lower than that when the piston speed is lower than the first predetermined value. Further, during the high-frequency compression stroke in which the piston frequency is equal to or higher than the predetermined value, the second damping force generation mechanism 332 does not open the disc valve 315.

“Compression Stroke in which Piston Frequency is Lower than Predetermined Value”

In a low-frequency compression stroke in which the piston frequency is lower than the predetermined value, the stroke of the piston 18 is large. Therefore, an amount of the working fluid L introduced from the lower chamber 20 into the back pressure chamber 301 via the first passage 184, the orifice 242 of the disc 141, the intermediate chamber 243 of the pin member 71, and the orifice 262 of the disc 136, all of which constitute the flow path 331, is large. Therefore, although the working fluid L flows from the lower chamber 20 to the back pressure chamber 301 at the beginning of the stroke of the piston 18, thereafter, the valve member 131 deforms to near the limit and does not deform more than that. As a result, even at the same piston speed, when the piston frequency is a low frequency lower than the predetermined value, the pressure in the back pressure chamber 301 becomes higher than that when the piston frequency is a high frequency equal to or higher than the predetermined value.

During the low-frequency compression stroke in which the piston frequency is lower than the predetermined value as described above, when the moving speed of the piston 18 is lower than a third predetermined value, the working fluid L from the lower chamber 20 flows into the reservoir chamber 6 through the fixed orifice 244 of the first damping force generation mechanism 251 in the flow path 252. Therefore, a damping force having orifice characteristics is generated. Therefore, the damping force characteristics with respect to the piston speed when the piston speed is lower than the third predetermined value are such that an increasing rate of the damping force with respect to an increase in the piston speed is relatively high.

In the low-frequency compression stroke in which the piston frequency is lower than the predetermined value, since the pressure in the back pressure chamber 301 increases as described above, the damping valve 250 of the first damping force generation mechanism 251 is difficult to open. Therefore, when the piston speed is equal to or higher than the third predetermined value and lower than a fourth predetermined value, the working fluid L from the lower chamber 20 passes through the first passage 184, the orifice 242 of the disc 141, the intermediate chamber 243 of the pin member 71, the orifice 312 of the disc 124, and the chamber 325, all of which constitute the flow path 331, without opening the damping valve 250 of the first damping force generation mechanism 251 in the flow path 252, and then flows into the reservoir chamber 6 through between the disc valve 315 and the valve seat part 225 while opening the disc valve 315 of the second damping force generation mechanism 332. Therefore, a damping force having valve characteristics is generated. Therefore, the damping force characteristics with respect to the piston speed when the piston speed is equal to or higher than the third predetermined value and lower than the fourth predetermined value are such that an increasing rate of the damping force with respect to an increase in the piston speed is lower than that when the piston speed is lower than the third predetermined value.

When the piston speed is equal to or higher than a fourth predetermined value, the working fluid L from the lower chamber 20 flows into the reservoir chamber 6 while opening the disc valve 315 of the second damping force generation mechanism 332, and also flows into the reservoir chamber 6 through the flow path 252 including a gap between the damping valve 250 and the valve seat part 167 while opening the damping valve 250 of the first damping force generation mechanism 251 in which an opening thereof has been restricted due to the pressure in the back pressure chamber 301. Therefore, the damping force characteristics with respect to the piston speed when the piston speed is equal to or higher than the fourth predetermined value are such that an increasing rate of the damping force with respect to an increase in the piston speed is lower than that when the piston speed is equal to or higher than the third predetermined value and lower than the fourth predetermined value.

In the base valve 25, even if the piston speed is the same, during the low-frequency compression stroke in which the piston frequency is lower than the predetermined value, the pressure in the back pressure chamber 301 is higher than that during the high-frequency compression stroke in which the piston frequency is equal to or higher than the predetermined value. Therefore, even if the piston speed is the same, during the low-frequency compression stroke in which the piston frequency is lower than the predetermined value, the damping valve 250 of the first damping force generation mechanism 251 is more difficult to open than during the high-frequency compression stroke in which the piston frequency is equal to or higher than the predetermined value. Thereby, even if the piston speed is the same, during the low-frequency compression stroke in which the piston frequency is lower than the predetermined value, the damping force exhibits harder characteristics than during the high-frequency compression stroke in which the piston frequency is equal to or higher than the predetermined value.

### [Extension Stroke]

In the extension stroke, the pressure in the lower chamber 20 becomes lower than the pressure in the reservoir chamber 6, but the valve disc 291 of the valve member 131 of the frequency sensitive part 335 comes into contact with the seat part 284 of the pilot case retainer 135 to suppress expansion of the bottom side chamber 302. Therefore, an amount of the working fluid L introduced from the reservoir chamber 6 into the bottom side chamber 302 through the passage 229 is suppressed. As a result, a flow rate of the working fluid L introduced from the reservoir chamber 6 into the first passage 194, passing through the first damping force generation mechanism 355, and flowing into the lower chamber 20 does not decrease. Therefore, the damping force is almost the same as when the frequency sensitive part 335 is not provided.

In the extension stroke, when the piston speed is lower than a fifth predetermined value, the working fluid L from the reservoir chamber 6 flows into the lower chamber 20 through the fixed orifice 341 of the first damping force generation mechanism 355 in the flow path 356. Therefore, a damping force having orifice characteristics (in which the damping force is substantially proportional to the square of the piston speed) is generated. Therefore, the damping force characteristics with respect to the piston speed when the piston speed is lower than the fifth predetermined value are such that an increasing rate of the damping force with respect to an increase in the piston speed is relatively high.

In the extension stroke, when the piston speed is equal to or higher than the fifth predetermined value, the working fluid L from the reservoir chamber 6 opens the valve disc 145 of the first damping force generation mechanism 355 in the flow path 356 and flows into the lower chamber 20 through a gap between the valve disc 145 and the valve seat part 163. Therefore, a damping force having valve characteristics (in which the damping force is substantially proportional to the piston speed) is generated. Therefore, the damping force characteristics with respect to the piston speed when the piston speed is equal to or higher than the fifth predetermined value are such that an increasing rate of the damping force with respect to an increase in the piston speed is lower than that when the piston speed is lower than the fifth predetermined value.

Here, in the extension stroke, when the piston speed increases and a pressure in the bottom side chamber 302 becomes higher than the pressure in the back pressure chamber 301 by a predetermined value or more, the inner circumferential side of the valve member 131 separates from the disc 127. In other words, the check valve 338 opens. Thereby, the working fluid L flows from the reservoir chamber 6 to the lower chamber 20 via the passage 229, the bottom side chamber 302, the check valve 338, the back pressure chamber 301, the orifice 262 of the disc 136, the intermediate chamber 243 of the pin member 71, the orifice 242 of the disc 141, and the first passage 184, all of which constitute the flow path 331. That is, the working fluid L flows from the reservoir chamber 6 to the lower chamber 20 through the flow path 331. In this way, the valve member 131 reduces a differential pressure between the bottom side chamber 302 side and the back pressure chamber 301 side when the check valve 338 opens. Therefore, excessive bending of the valve member 131 is suppressed.

Patent Documents 1 and 2 described above disclose shock absorbers having a partition member provided on a bottom part side in a cylinder to partition a cylinder inner chamber and a reservoir chamber and having a frequency sensitive part provided in the partition member. In this type of shock absorber, there is a likelihood that a flow path area of a flow path that allows communication between the cylinder inner chamber and the reservoir cannot be secured. For example, in the shock absorbers described in Patent Documents 1 and 2, a frequency sensitive part is provided on the cylinder inner chamber side of the partition member that partitions the cylinder inner chamber and the reservoir chamber. In these shock absorbers, a flow path to the frequency sensitive part is provided on a central shaft of a pin member for fastening each component of the partition member. For this reason, these shock absorbers may have a low degree of freedom in increasing a flow path area of the flow path and may not be able to secure performance of the frequency sensitive part. Particularly, in a variable flow rate type frequency sensitive mechanism, an effect due to the frequency sensitive part is small.

In contrast, the shock absorber 1 of the first embodiment includes the frequency sensitive part 335 provided on the bottom part 12 side of the partition member 142 that partitions the lower chamber 20 and the reservoir chamber 6. Then, the shock absorber 1 has a structure in which the flow path 331 that allows communication between the lower chamber 20 and the reservoir chamber 6 is provided in the partition member 142, and the working fluid L is supplied to the frequency sensitive part 335 through the flow path 331. Therefore, the shock absorber 1 has a high degree of freedom in increasing a flow path area of the flow path 331 to the frequency sensitive part 335. Therefore, in the shock absorber 1, a flow path area of the flow path 331 for introducing the working fluid L into the frequency sensitive part 335 can be secured. As a result, the shock absorber 1 can secure a frequency sensitivity performance of the frequency sensitive part 335.

Also, in the shock absorber 1, the base member 26, to which an axial force of the inner cylinder 3 of the cylinder 2 is applied, is disposed on the bottom part 12 side of the cylinder 2 with respect to the frequency sensitive part 335. Therefore, it is possible to have a structure in which the flow path 331, in which the frequency sensitive part 335 is provided, is not provided in the base member 26. Therefore, the base member 26, to which the axial force of the inner cylinder 3 of the cylinder 2 is applied, can be made thin while securing a strength thereof. As a result, an axial length of the base valve 25 can be reduced.

Also, in the shock absorber 1, since the partition member 142, the frequency sensitive part 335, and the base member 26 are fixed to the pin member 71 that penetrates them, productivity can be improved.

Also, in the shock absorber 1, since the hardness of the partition member 142 and the hardness of the base member 26 are different, it is possible to suppress an increase in cost compared to a case in which both hardnesses are high.

Also, in the shock absorber 1, since the material of the partition member 142 and the material of the base member 26 are different, it is possible to suppress an increase in cost compared to a case in which both materials are the same.

### Second Embodiment

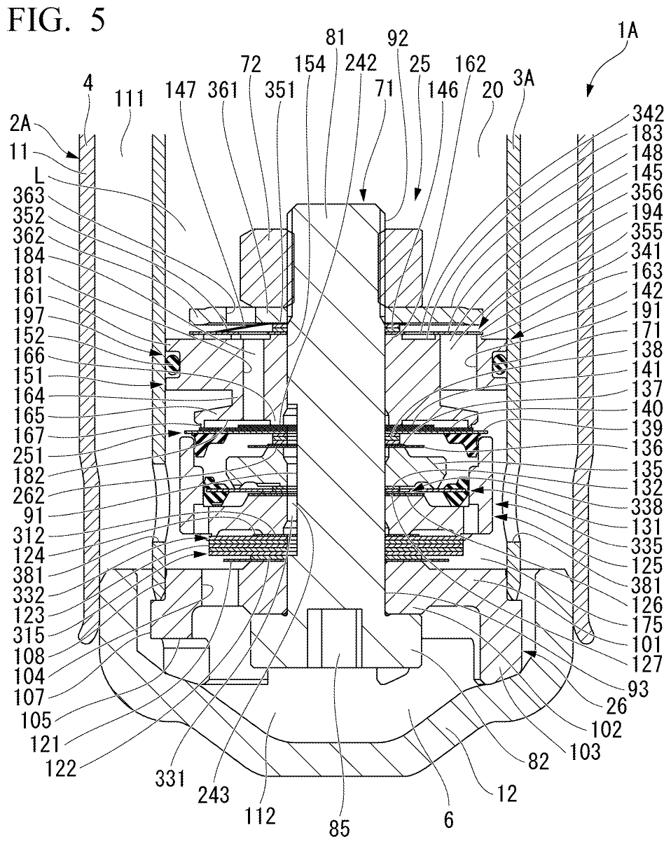

Next, a second embodiment will be described mainly on the basis of FIG. 5, focusing on the differences from the first embodiment. Further, portions common to those in the first embodiment will be denoted by the same terms and the same reference signs.

As illustrated in FIG. 5, a shock absorber 1A of the second embodiment includes a cylinder 2A, which is partially different from the cylinder 2, instead of the cylinder 2. The cylinder 2A includes an inner cylinder 3A, which is partially different from the inner cylinder 3, instead of the inner cylinder 3.

The inner cylinder 3A includes a hole 381 formed between a partition member 142 and a base member 26 in an axial direction thereof to penetrate the inner cylinder 3A in a radial direction thereof. The hole 381 is formed between a partition part 197 and the base member 26 in the axial direction of the inner cylinder 3. In other words, the hole 381 penetrating the inner cylinder 3A in the radial direction is formed in the inner cylinder 3A at a position of an outer circumferential chamber 175 in the axial direction. A plurality of holes 381 are provided in the inner cylinder 3A at regular intervals in a circumferential direction of the inner cylinder 3. The hole 381 is provided to face a frequency sensitive part 335. In a reservoir chamber 6, a cylindrical chamber 111 and the outer circumferential chamber 175 communicate with each other through a passage in the hole 381.

In the shock absorber 1A of the second embodiment, the hole 381 is formed at a position between the partition member 142 and the base member 26 in the inner cylinder 3. Therefore, the shock absorber 1A can increase a flow rate of a working fluid L from the cylindrical chamber 111 to the outer circumferential chamber 175 by an extent to which the hole 381 is formed. Therefore, the shock absorber 1A can suppress a shortage in a flow rate of the working fluid L suctioned from the reservoir chamber 6 to a lower chamber 20 due to a first damping force generation mechanism 355 during an extension stroke.

Here, in the shock absorber 1A, if there is no need to increase a flow rate of the working fluid L from the cylindrical chamber 111 to the outer circumferential chamber 175, a passage of the base member 26 that allows communication between the outer circumferential chamber 175 and a bottom chamber 112, and a passage of the base member 26 that allows communication between the bottom chamber 112 and the cylindrical chamber 111 can be made smaller or eliminated. Thereby, the shock absorber 1A can enhance a strength of the base member 26 or can be made smaller by shortening the base member 26 in the axial direction.

### Third Embodiment

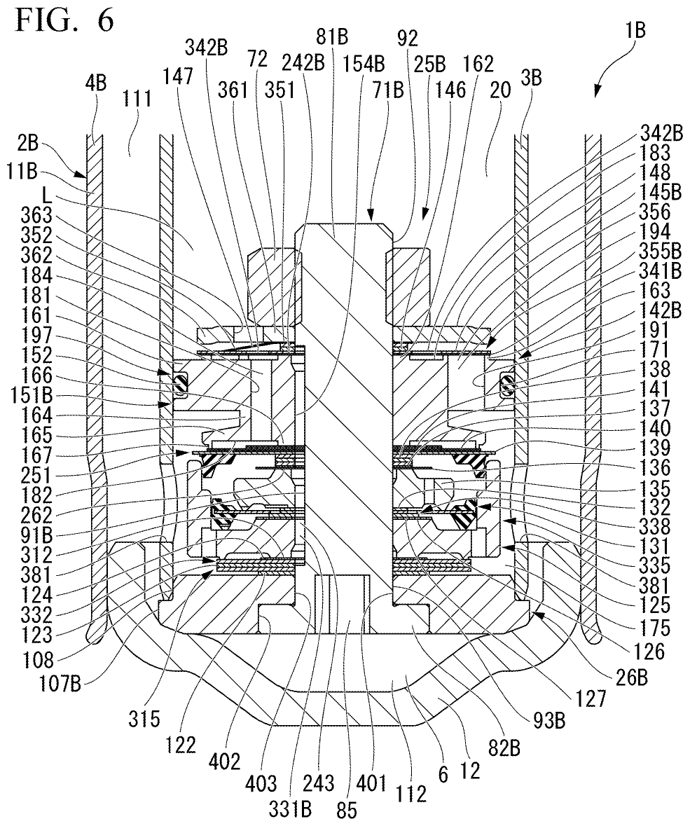

Next, a third embodiment will be described mainly on the basis of FIG. 6, focusing on the differences from the second embodiment. Further, portions common to those in the second embodiment will be denoted by the same terms and the same reference signs.

As illustrated in FIG. 6, a shock absorber 1B of the third embodiment includes a base valve 25B (partition member), which is partially different from the base valve 25, instead of the base valve 25. The base valve 25B includes a base member 26B (second partition member), which is partially different from the base member 26, instead of the base member 26.

The base member 26B has a disc shape. The base member 26B has a through hole 401 formed at a center in a radial direction. The through hole 401 penetrates the base member 26B in an axial direction. The through hole 401 has a large diameter hole portion 402 and a small diameter hole portion 403. An inner diameter of the large diameter hole portion 402 is larger than an inner diameter of the small diameter hole portion 403. The through hole 401 has a large diameter hole portion 402 on a bottom part 12 side in an axial direction of the base member 26B, and a small diameter hole portion 403 on a side of the large diameter hole portion 402 opposite to the bottom part 12 in the axial direction of the base member 26B.

A large diameter portion 107B having a smaller axial length than the large diameter portion 107 is formed at an outer circumferential portion of the base member 26B instead of the large diameter portion 107.

The through holes 104 and the through grooves 105 of the base member 26 are not formed in the base member 26B. Also, the leg part 103 of the base member 26 is not formed in the base member 26B. Therefore, the base member 26B has a smaller axial length than the base member 26.

The base valve 25B includes a pin member 71B (shaft member), which is partially different from the pin member 71, instead of the pin member 71. The pin member 71B has a shaft part 81B having a smaller axial length than the shaft part 81. The shaft part 81B has a fitting shaft part 93B having a smaller axial length than the fitting shaft part 93. The shaft part 81B has a groove part 91B whose length in an axial direction of the shaft part 81B is larger than the groove part 91. The pin member 71B includes a head part 82B having a smaller axial length than the head part 82. The head part 82B of the pin member 71B is inserted into the large diameter hole portion 402 of the base member 26B. The fitting shaft part 93B of the pin member 71B is fitted into the small diameter hole portion 403 of the base member 26B.

The base valve 25B includes a partition member 142B (first partition member), which is partially different from the partition member 142, instead of the partition member 142. The partition member 142B includes a partition member main body 151B, which is partially different from the partition member main body 151, instead of the partition member main body 151. The partition member main body 151B has a through hole 154B having a shape that is an inversion of the through hole 154 in the axial direction. Therefore, the through hole 154B has a larger diameter at an end portion on an inner seat part 162 side in the axial direction than at the remaining portion. The fitting shaft part 93B of the pin member 71B is fitted in a portion with a smaller diameter of the through hole 154B.

The base valve 25B includes a first damping force generation mechanism 355B, which is partially different from the first damping force generation mechanism 355, instead of the first damping force generation mechanism 355. The first damping force generation mechanism 355B includes two valve discs 145B. A through hole 342B similar to the through hole 342 is formed in the valve disc 145B of the two valve discs 145B on a side opposite to a valve seat part 163 in the axial direction. Also, the through hole 342B similar to the through hole 342, a fixed orifice 341B similar to the fixed orifice 341, and an orifice 242B are formed in the valve disc 145B of the two valve discs 145B on the valve seat part 163 side in the axial direction. One end side of the orifice 242B is in constant communication with an intermediate chamber 243, and the other end side thereof is in constant communication with the through hole 342B. The first damping force generation mechanism 355B operates in the same manner as the first damping force generation mechanism 355 during an extension stroke.

In the base valve 25B, the orifice 242 is not formed in a disc 141.

The base valve 25B has a flow path 331B which is partially different from the flow path 331. The flow path 331B has a passage in the through hole 342B and the orifice 242B instead of the first passage 184 and the orifice 242.

In the base valve 25B, a working fluid L from a lower chamber 20 flows into the intermediate chamber 243 via a passage in the through hole 342B and the orifice 242B in the flow path 331B. Also, in the base valve 25B, the working fluid L from the intermediate chamber 243 flows into the lower chamber 20 via the orifice 242B and the passage in the through hole 342B. Except for these points, the base valve 25B operates in the same manner as the base valve 25.

The shock absorber 1B includes a cylinder 2B, which is partially different from the cylinder 2, instead of the cylinder 2A. The cylinder 2B includes an inner cylinder 3B, which is partially different from the inner cylinder 3A, instead of the inner cylinder 3A. The inner cylinder 3B is shorter than the inner cylinder 3A in the axial direction by an extent to which an axial length of the base member 26B is made smaller than an axial length of the base member 26. The cylinder 2B has an outer cylinder 4B, which is partially different from the outer cylinder 4, instead of the outer cylinder 4. The outer cylinder 4B includes a barrel part 11B that is shorter than the barrel part 11 by an extent to which the axial length of the base member 26B is made smaller than the axial length of the base member 26.

A hole 381 similar to that of the inner cylinder 3 is also formed in the inner cylinder 3B between the partition member 142B and the base member 26B in the axial direction. The hole 381 is formed between a partition part 197 and the base member 26B in an axial direction of the inner cylinder 3B. In other words, the hole 381 penetrating the inner cylinder 3B in the radial direction is formed in the inner cylinder 3B at a position of an outer circumferential chamber 175 in the axial direction. Therefore, in a reservoir chamber 6, a cylindrical chamber 111 and the outer circumferential chamber 175 communicate with each other through a passage in the hole 381.

In the shock absorber 1B of the third embodiment, the hole 381 is formed in the inner cylinder 3B at a position between the partition member 142B and the base member 26. Then, in the shock absorber 1B, the passage that allows communication between the outer circumferential chamber 175 and the bottom chamber 112 and the passage that allows communication between the bottom chamber 112 and the cylindrical chamber 111 are not formed in the base member 26B. Thereby, in the shock absorber 1B, the base member 26B can be made smaller by shortening it in the axial direction while securing a strength thereof.

### Fourth Embodiment

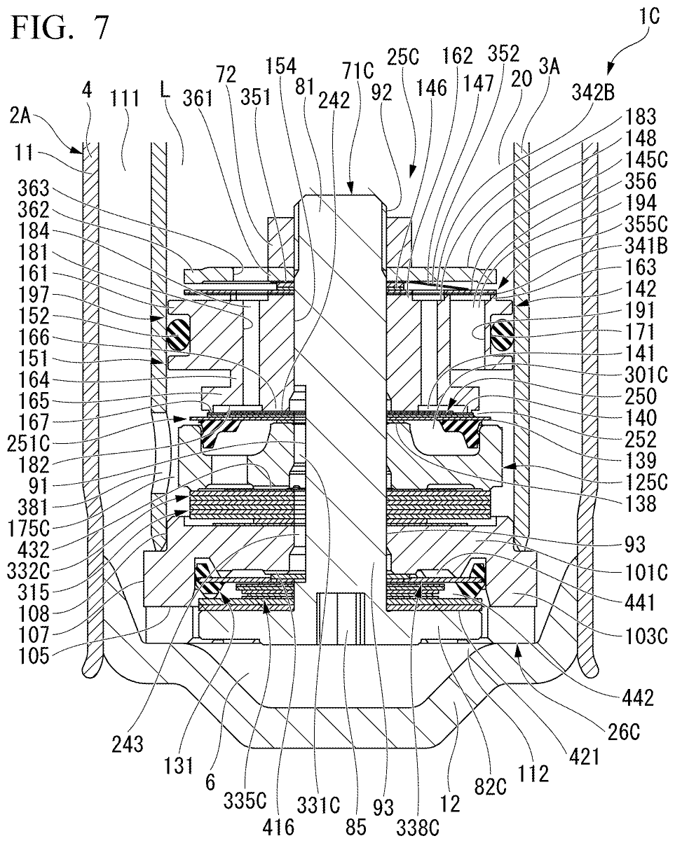

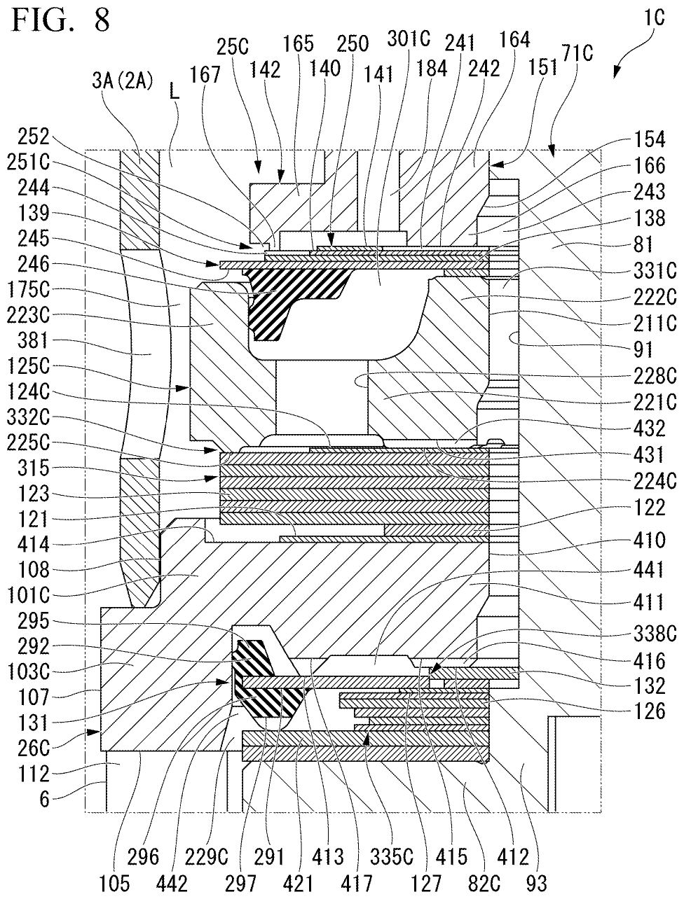

Next, a fourth embodiment will be described mainly on the basis of FIGS. 7 and 8, focusing on the differences from the first to third embodiments. Further, portions common to those in the first to third embodiments will be denoted by the same terms and the same reference signs.

As illustrated in FIG. 7, a shock absorber 1C of the fourth embodiment includes a base valve 25C (partition member), which is partially different from the base valve 25, instead of the base valve 25. The base valve 25C includes a pin member 71C (shaft member), which is partially different from the pin member 71, instead of the pin member 71. The pin member 71C includes a head part 82C, which has a larger outer diameter than the head part 82, instead of the head part 82.

The base valve 25C includes a base member 26C (second partition member), which is partially different from the base member 26, instead of the base member 26. The base member 26C includes a disc-shaped part 101C and a leg part 103C.

The disc-shaped part 101C has a disc shape and has a through hole 410 formed at a center in a radial direction thereof as illustrated in FIG. 8. The through hole 410 penetrates the disc-shaped part 101C in an axial direction thereof. Therefore, the disc-shaped part 101C has an annular shape. The disc-shaped part 101C includes a base plate part 411, a protruding part 412, a seat part 413, and a recess-shaped part 414.

The base plate part 411 has a disc shape and has the through hole 410 formed at a center in the radial direction. Therefore, the base plate part 411 has a bored disc shape.

The protruding part 412 has an annular shape. The protruding part 412 protrudes from an inner circumferential edge portion of the base plate part 411 in an axial direction of the base plate part 411. A groove part 415 penetrating the protruding part 412 in a radial direction of the protruding part 412 is formed in the protruding part 412. The inside of the groove part 415 is an orifice 416. The orifice 416 is in constant communication with an intermediate chamber 243 inside the groove part 91 of the pin member 71C. Here, the through hole 410 has a larger diameter at an end portion on the protruding part 412 side in an axial direction of the disc-shaped part 101C than at the remaining portion. A fitting shaft part 93 of the pin member 71C is fitted in a portion with a smaller diameter of the through hole 410.

The seat part 413 has an annular shape. The seat part 413 is provided on an outer side of the protruding part 412 in a radial direction of the base plate part 411. The seat part 413 protrudes from the base plate part 411 to the same side as the protruding part 412 in the axial direction of the base plate part 411. The seat part 413 has a plurality of notch parts 417 formed at a distal end portion on the protruding side to penetrate the distal end portion in a radial direction of the seat part 413 at intervals in a circumferential direction of the seat part 413. Therefore, the distal end portion on the protruding side of the seat part 413 is intermittently cut out in the circumferential direction of the seat part 413. In the axial direction of the base plate part 411, a protruding height of the seat part 413 from the base plate part 411 is larger than a protruding height of the protruding part 412 from the base plate part 411.

The recess-shaped part 414 is recessed in a direction of the protruding part 412 and the seat part 413 from an end surface of the base plate part 411 on a side opposite to the protruding part 412 and the seat part 413 in the axial direction.

The leg part 103C has a cylindrical shape and is formed at an outer circumferential portion of the disc-shaped part 101C on a radially outer side of the seat part 413. The leg part 103C protrudes from the base plate part 411 of the disc-shaped part 101C to the same side as the seat part 413 in the axial direction of the disc-shaped part 101C. The leg part 103C is substantially similar to the leg part 103 and has a through groove 105 formed therein. A large diameter portion 107 and a small diameter portion 108 similar to those in the first to third embodiments are formed at an outer circumferential portion of the base member 26C.

The base valve 25C includes a plurality of (specifically, two) discs 132 similar to those in the first to third embodiments and one valve member 131 similar to that in the first to third embodiments on the protruding part 412 side of the disc-shaped part 101C and on a radially inner side of the leg part 103C in the base member 26C. The discs 132 are in contact with the protruding part 412 of the base member 26C. The valve member 131 is fitted in an inner circumferential portion of the leg part 103C at a seal part 295 of an elastic seal member 292 and is in contact with the seat part 413 at a valve disc 291.

Also, the base valve 25C includes a disc 127 and a plurality of discs 126, all of which are similar to those in the first to third embodiments, on a side of the discs 132 and the valve member 131 opposite to the disc-shaped part 101C in order from a side of the discs 132 and the valve member 131. Also, the base valve 25C includes a plurality of (specifically, two) discs 421 on a side of the disc 126 opposite to the disc 127. The discs 421 are made of a metal and have a bored circular flat plate shape with a constant thickness. The fitting shaft part 93 of a shaft part 81 of the pin member 71C is fitted on an inner circumferential side of the discs 421. The discs 421 have an outer diameter larger than an outer diameter of the disc 126.

The base valve 25C includes a disc 121, a disc 122, and a plurality of (specifically, five) discs 123, all of which are similar to those in the first to third embodiments, on a side of the disc-shaped part 101C of the base member 26C opposite to the leg part 103C in the axial direction in order from the base member 26C side. The base valve 25C includes a disc 124C and a pilot case 125C on a side of the discs 123 opposite to the disc 122 in order from the discs 123 side.

The disc 124C differs from the disc 124 in that the notch 311 is not formed.

The pilot case 125C has a different shape from the pilot case 125. The pilot case 125C has a bottomed cylindrical shape. A through hole 211C is formed at a center of the pilot case 125C in the radial direction. The through hole 211C penetrates the pilot case 125C in an axial direction thereof. The through hole 211C has a larger diameter at an end portion on the disc 124C side in the axial direction than at the remaining portion. The fitting shaft part 93 of the pin member 71C is fitted in a portion with a smaller diameter of the through hole 211C.

The pilot case 125C includes a bottom part 221C, an inner cylindrical part 222C, an outer cylindrical part 223C, an inner seat part 224C, and a valve seat part 225C.

The bottom part 221C has a bored disc shape. A passage hole 228C penetrating the bottom part 221C in an axial direction of the bottom part 221C is formed in the bottom part 221C on a radially outer side of the through hole 211C.

The inner cylindrical part 222C has an annular shape and protrudes from an inner circumferential edge portion of the bottom part 221C to a side opposite to the disc 124C in the axial direction of the bottom part 221C.

The outer cylindrical part 223C has a cylindrical shape and protrudes from an outer circumferential edge portion of the bottom part 221C to the same side as the inner cylindrical part 222C in the axial direction of the bottom part 221C.

The inner seat part 224C has an annular shape and protrudes from the inner circumferential edge portion of the bottom part 221C to a side opposite to the inner cylindrical part 222C in the axial direction. The inner seat part 224C includes a groove part 431 formed to penetrate the inner seat part 224C in a radial direction of the inner seat part 224C. The inside of the groove 431 is an orifice 432. The orifice 432 is in constant communication with the intermediate chamber 243 in the groove part 91 of the pin member 71C. The inner seat part 224C of the pilot case 125C is in contact with the disc 124C.

The valve seat part 225C has an annular shape with a larger diameter than the inner seat part 224C. The valve seat part 225C is on an outer side of the inner seat part 224C in a radial direction of the bottom part 221C. The valve seat part 225C protrudes from the bottom part 221C to the same side as the inner seat part 224C in the axial direction of the bottom part 221C. The passage hole 228C of the bottom part 221C is disposed between the valve seat part 225C and the inner seat part 224C in the radial direction of the bottom part 221C.

The base valve 25C includes one disc 138 similar to that in the first to third embodiments, and a pilot disc 139, a plurality of (specifically, two) discs 140, a disc 141, and a partition member 142 (first partition member), all of which are similar to those in the first to third embodiments, in that order on a side of the pilot case 125C opposite to the disc 124C in the axial direction.

The disc 140 has a fixed orifice 244 similar to that in the first to third embodiments. The disc 141 has an orifice 242 similar to that in the first to third embodiments. The orifice 242 is in constant communication with the intermediate chamber 243 in the groove part 91 of the pin member 71C. Similarly to the first to third embodiments, the plurality of discs 140 and the pilot disc 139 constitute a damping valve 250, and a valve seat part 167 of the partition member 142 and the damping valve 250 constitute a first damping force generation mechanism 251C that is substantially similar to the first damping force generation mechanism 251.

Also, the base valve 25C includes two valve discs 145C that are partially different from the valve disc 145B of the third embodiment, and a plurality of (specifically, two) discs 146, a spring disc 147, a restriction disc 148, and a nut member 72, all of which are similar to those in the first to third embodiments, in that order on a side of the partition member 142 opposite to the disc 141 in the axial direction as illustrated in FIG. 7. Similarly to the third embodiment, the valve discs 145C have a through hole 342B and a fixed orifice 341B, but the orifice 242B is not formed therein. The valve disc 145C constitutes a first damping force generation mechanism 355C.

As illustrated in FIG. 8, the disc 421, the disc 126, the disc 127, the disc 132 and valve member 131, the base member 26C, the disc 121, the disc 122, the disc 123, the disc 124C, the pilot case 125C, the disc 138, the pilot disc 139, the disc 140, the disc 141, and the partition member 142 are stacked in that order on the head part 82C of the pin member 71C with the shaft part 81 of the pin member 71C inserted through the inside of them. In addition, the valve disc 145C, the disc 146, the spring disc 147, and the restriction disc 148 are stacked on the partition member 142 in that order with the shaft part 81 of the pin member 71C inserted through the inside of them as illustrated in FIG. 7. In this state, the nut member 72 is screwed onto a screw part 92 of the pin member 71C. Then, the members from the disc 421 to the restriction disc 148, except for the valve member 131, are clamped by the head part 82C of the pin member 71C and the nut member 72 at least at their inner circumferential side.

In this state, the seal member 246 of the pilot disc 139 is fitted in a liquid-tight manner to an inner circumferential portion of the outer cylindrical part 223C of the pilot case 125C over the entire circumference as illustrated in FIG. 8. The seal member 246 is slidable in the axial direction with respect to the outer cylindrical part 223C. The seal member 246 constantly seals a gap between the pilot disc 139 and the outer cylindrical part 223C.

The valve member 131 is disposed on a radially inner side of the leg part 103C of the base member 26C. The valve member 131 is press-fitted into the leg part 103C of the base member 26C at the seal part 295 thereof. Due to this press fitting, the valve member 131 is centered to be disposed coaxially with the base member 26C, the plurality of discs 132, and the pin member 71C. At that time, the seal part 295 of the valve member 131 is in contact with the leg part 103C over the entire circumference with a fastening allowance in the radial direction. In other words, the seal part 295 of the valve member 131 is in close contact with the leg part 103C of the base member 26C over the entire circumference. Thereby, the seal part 295 of the valve member 131 fits into the leg part 103C of the base member 26C in a liquid-tight manner over the entire circumference.

The seal part 295 is slidable with respect to the leg part 103C in an axial direction of the leg part 103C. At that time, the seal part 295 slides in the axial direction with respect to the leg part 103C while maintaining a state in close contact with the leg part 103C over the entire circumference. Thereby, the seal part 295 of the elastic seal member 292 constantly seals a gap between the valve member 131 and the leg part 103C. The valve disc 291 of the valve member 131 is in contact with the seat part 413. Further, the through groove 105 of the leg part 103C is formed on the bottom part 12 side of the cylinder 2A illustrated in FIG. 7 with respect to a range in which the seal part 295 of the leg part 103C slides.

As illustrated in FIG. 8, an inner circumferential side of the valve disc 291 of the valve member 131 is disposed between the protruding part 412 and the disc 127 in the axial direction and is supported in contact with the disc 127. The inner circumferential side of the valve disc 291 of the valve member 131 is movable in a range of an entire axial length of the plurality of (specifically, two) discs 132 between the protruding part 412 and the disc 127. The inner circumferential side of the valve disc 291 of the valve member 131 is supported by the disc 127 on only one side without being clamped from both sides. In the valve member 131, a portion of the valve disc 291 on a radially outer side of the disc 127 is supported by the seat part 413 on only one side without being clamped from both sides. Therefore, the valve member 131 has a simple support structure in which one side of the valve disc 291 is supported by the disc 127 and the other side of the valve disc 291 is supported by the seat part 413. In other words, the valve disc 291 is not clamped in the axial direction. The valve member 131 has an annular shape as a whole and is elastically deformable, that is, bendable.

The contact part 296 of the valve member 131 is in contact with the discs 421. The discs 421 and the head part 82C of the pin member 71C suppress movement of the valve member 131 to a side opposite to the seat part 413 in an axial direction of the base member 26C.

The seat part 413 of the base member 26C supports an outer circumferential side of the valve disc 291 of the valve member 131 from one side in the axial direction. The disc 127 supports the inner circumferential side of the valve disc 291 with respect to the seat part 413 from the other side in the axial direction. A distance between the seat part 413 and the disc 127 in the axial direction is slightly smaller than a thickness of the valve disc 291 in the axial direction. Therefore, the valve disc 291 presses against both the seat part 413 and the disc 127 with its own elastic force in a state of being elastically deformed into a slightly tapered shape. That is, the valve disc 291 is seated on the disc 127 by its own elastic force. The valve disc 291 can be separated from the disc 127 by a pressure applied to the valve member 131.

The base valve 25C includes a back pressure chamber 301C surrounded by the outer cylindrical part 223C of the pilot case 125C, the pilot disc 139, and the disc 138. The inside of the passage hole 228C of the pilot case 125C also constitutes the back pressure chamber 301C. The back pressure chamber 301C applies a pressure to the plurality of discs 140 in a direction of the partition member 142 via the pilot disc 139. In other words, the back pressure chamber 301C applies an internal pressure to the damping valve 250 in a valve closing direction in which the damping valve 250 is seated on the valve seat part 167. The back pressure chamber 301C also constitutes the first damping force generation mechanism 251C together with the valve seat part 167 and the damping valve 250. The first damping force generation mechanism 251C differs from the first damping force generation mechanism 251 in that it has the back pressure chamber 301C that is different from the back pressure chamber 301. The back pressure chamber 301C is in constant communication with the intermediate chamber 243 of the pin member 71C via the orifice 432 in the groove part 431 of the pilot case 125C. A working fluid L is introduced into the back pressure chamber 301C from a lower chamber 20 illustrated in FIG. 7 via the first passage 184 of the partition member 142, the orifice 242 of the disc 141 illustrated in FIG. 8, the intermediate chamber 243 of the pin member 71C, and the orifice 432 of the pilot case 125C. The first damping force generation mechanism 251C controls an opening of the damping valve 250 using the pressure in the back pressure chamber 301C.

The valve member 131 is provided inside the base member 26C and partitions the inside of the base member 26C into a variable chamber 441 and a communication chamber 442.

The variable chamber 441 is formed by being surrounded by the disc-shaped part 101C of the base member 26C, a portion of the leg part 103C on the disc-shaped part 101C side, the valve member 131, and the discs 127 and 132.

The variable chamber 441 is in constant communication with the lower chamber 20 illustrated in FIG. 7 via the orifice 416 of the base member 26C, the intermediate chamber 243 of the pin member 71C, the orifice 242 of the disc 141, and the first passage 184 of the partition member 142. Also, as illustrated in FIG. 8, the variable chamber 441 is in constant communication with the back pressure chamber 301C via the orifice 416 of the base member 26C, the intermediate chamber 243 of the pin member 71C, and the orifice 432 of the pilot case 125C. Therefore, the pressure in the back pressure chamber 301C changes according to a pressure in the variable chamber 441 into which the working fluid L is introduced from the lower chamber 20 illustrated in FIG. 7 via the first passage 184 of the partition member 142, the orifice 242 of the disc 141 illustrated in FIG. 8, the intermediate chamber 243 of the pin member 71C, and the orifice 416 of the base member 26C. The first damping force generation mechanism 251C controls an opening of the damping valve 250 using the pressure in the back pressure chamber 301C that changes according to the pressure in the variable chamber 441 as described above.

The communication chamber 442 is formed by being surrounded by a portion of the base member 26C on a side opposite to the disc-shaped part 101C of the leg part 103C, the valve member 131, and the discs 126, 127, and 421.

The communication chamber 442 is on the bottom part 12 side of the cylinder 2A illustrated in FIG. 7 with respect to the valve member 131 in the axial direction of the base member 26C. In the communication chamber 442, an outer chamber and an inner chamber of the contact part 296 in the radial direction are in constant communication with each other through a passage in a notch part 297 of the valve member 131 illustrated in FIG. 8.

When the valve disc 291 of the valve member 131 is separated from the disc 127, the communication chamber 442 communicates with the variable chamber 441 through a passage between the valve disc 291 and the disc 127. The communication chamber 442 is in constant communication with the bottom chamber 112 of the reservoir chamber 6 through a passage 229C between the leg part 103C of the base member 26C and the disc 421.

The discs 121 to 123, and 124C are provided between the inner seat part 224C of the pilot case 125C and the disc-shaped part 101C of the base member 26C in the axial direction. Among the discs 121 to 123, and 124C, the discs 121 and 122 and a part of the disc 123 are disposed in the recess-shaped part 414 of the base member 26C. The disc 121 is in contact with a bottom surface of the recess-shaped part 414 of the base member 26C.

As illustrated in FIG. 7, a portion between an outer circumferential portion of the base valve 25C and an inner circumferential portion of the inner cylinder 3A and between the partition part 197 and the base member 26C is an outer circumferential chamber 175C. The outer circumferential chamber 175C communicates with the cylindrical chamber 111 through the hole 381 of the inner cylinder 3A. Therefore, the outer circumferential chamber 175C also constitutes the reservoir chamber 6.

When a disc valve 315 formed of the plurality of discs 123 is separated from the valve seat part 225C illustrated in FIG. 8, the working fluid L from the lower chamber 20 flows into the outer circumferential chamber 175C of the reservoir chamber 6 via the first passage 184, the orifice 242 of the disc 141, the intermediate chamber 243 of the pin member 71C, the orifice 432 of the pilot case 125C, the back pressure chamber 301C, and a passage between the disc valve 315 and the valve seat part 225C. At that time, the disc valve 315 suppresses a flow of the working fluid L between itself and the valve seat part 225C.

The first passage 184, the orifice 242 of the disc 141, the intermediate chamber 243 of the pin member 71C, the orifice 432 of the pilot case 125C, the back pressure chamber 301C, and the passage between the disc valve 315 and the valve seat part 225C constitute a flow path 331C (first flow path) that allows communication between the lower chamber 20 and the reservoir chamber 6 illustrated in FIG. 7. Therefore, the partition member 142 in which the first passage 184 is formed has a part of the flow path 331C. The flow path 331C further includes the orifice 416 of the base member 26C communicating with the intermediate chamber 243, the variable chamber 441, the passage between the valve disc 291 of the valve member 131 and the disc 127, the communication chamber 442, and the passage 229C between the leg part 103C of the base member 26C and the disc 421.

The disc valve 315 and the valve seat part 225C constitute a second damping force generation mechanism 332C. The second damping force generation mechanism 332C allows the working fluid L to flow from the lower chamber 20 illustrated in FIG. 7 to the reservoir chamber 6 through the flow path 331C illustrated in FIG. 8 when the disc valve 315 is separated from the valve seat part 225C during a compression stroke. At that time, the second damping force generation mechanism 332C generates a damping force by suppressing a flow of the working fluid L between the lower chamber 20 and the reservoir chamber 6 illustrated in FIG. 7.

The base member 26C, the discs 126, 127, 132, and 421, and the valve member 131 constitute a frequency sensitive part 335C. Therefore, the base valve 25C includes the frequency sensitive part 335C. The frequency sensitive part 335C includes the variable chamber 441 and the communication chamber 442. Both the variable chamber 441 and the communication chamber 442 are variable in capacity. Capacities of both the variable chamber 441 and the communication chamber 442 change due to deformation of the valve member 131. As illustrated in FIG. 7, the frequency sensitive part 335C is provided on the bottom part 12 side of the partition member 142 in the axial direction of the cylinder 2A. The frequency sensitive part 335C is provided on the bottom part 12 side with respect to the partition part 197 in the axial direction of the cylinder 2A. The frequency sensitive part 335C is provided on the bottom part 12 side of the base member 26C in the axial direction of the cylinder 2A. In the frequency sensitive part 335C, the working fluid L is supplied to the variable chamber 441 and the communication chamber 442. Therefore, the working fluid L is supplied to the frequency sensitive part 335C through the flow path 331C.

During the compression stroke of the shock absorber 1C, the base valve 25C is configured so that the working fluid L from the lower chamber 20 illustrated in FIG. 7 is introduced into the first passage 184, the orifice 242 of the disc 141 illustrated in FIG. 8, and the intermediate chamber 243 of the pin member 71C. Then, the working fluid L introduced into the intermediate chamber 243 is introduced into the back pressure chamber 301C through the orifice 432 of the pilot case 125C on one hand, and is introduced into the variable chamber 441 through the orifice 416 of the base member 26C on the other hand. When the working fluid L from the lower chamber 20 is introduced into the variable chamber 441, the valve disc 291 of the valve member 131 deforms into a tapered shape so that an outer circumferential side thereof is separated from the seat part 413 in an axial direction of the seat part 413 using a contact point with the disc 127 in contact as a fulcrum. At that time, the valve disc 291 compressively deforms the contact part 296 of the elastic seal member 292 that is in contact with the disc 421. A volume of the variable chamber 441 increases due to the deformation of the valve disc 291. Here, at the time of the deformation of the valve disc 291, a volume of the communication chamber 442 decreases. At that time, the working fluid L in the communication chamber 442 flows into the reservoir chamber 6 through the passage 229C between the leg part 103C of the base member 26C and the disc 421.

In the flow path 331C, the first passage 184, the orifice 242 of the disk 141, the intermediate chamber 243 of the pin member 71C, the orifice 432 of the pilot case 125C, the back pressure chamber 301C, the orifice 416 of the base member 26C, and the variable chamber 441 are in constant communication with the lower chamber 20 illustrated in FIG. 7. In the flow path 331C, the passage 229C between the leg part 103C of the base member 26C and the disc 421 illustrated in FIG. 8 and the communication chamber 442 are in constant communication with the reservoir chamber 6. The flow path 331C is a passage through which the working fluid L moves from the lower chamber 20 on an upstream side illustrated in FIG. 7 toward the reservoir chamber 6 on a downstream side during the compression stroke. The frequency sensitive part 335C is provided in the flow path 331C.

As illustrated in FIG. 8, the inner circumferential side of the valve disc 291 of the valve member 131 is movable in the axial direction between the protruding part 412 of the base member 26C and the disc 127. In a state in which the inner circumferential side of the valve disc 291 is in contact with the disc 127 over the entire circumference, the valve member 131 blocks a flow of the working fluid L between the variable chamber 441 and the communication chamber 442. Also, in a state in which the inner circumferential side of the valve disc 291 is separated from the disc 127, the valve member 131 allows a flow of the working fluid L between the communication chamber 442 and the variable chamber 441. The inner circumferential side of the valve disc 291 and the disc 127 constitute a check valve 338C. The check valve 338C is provided in the flow path 331C. The flow path 331C is a passage through which the working fluid L moves from the reservoir chamber 6 on an upstream side toward the lower chamber 20 on a downstream side illustrated in FIG. 7 during an extension stroke.

The check valve 338C restricts a flow of the working fluid L from the variable chamber 441 to the communication chamber 442 through the flow path 331C while allowing a flow of the working fluid L from the communication chamber 442 to the variable chamber 441 through the flow path 331C. The check valve 338C blocks communication between the lower chamber 20 and the reservoir chamber 6 through the flow path 331C during the compression stroke in which a pressure in the lower chamber 20 illustrated in FIG. 7 is higher than a pressure in the reservoir chamber 6. The check valve 338C allows communication between the reservoir chamber 6 and the lower chamber 20 through the flow path 331C during the extension stroke in which a pressure in the reservoir chamber 6 is higher than a pressure in the lower chamber 20. In this way, the flow path 331C allows communication between the lower chamber 20 and the reservoir chamber 6 when the check valve 338C opens.

Next, main operations of the base valve 25C of the shock absorber 1C will be described.

### [Compression Stroke]

“Compression Stroke in which Piston Frequency is Equal to or Higher than Predetermined Value”

In the compression stroke, the working fluid L from the lower chamber 20 is introduced into the intermediate chamber 243 of the pin member 71C via the first passage 184 and the orifice 242 of the disc 141. The working fluid L introduced into the intermediate chamber 243 is introduced into the back pressure chamber 301C through the orifice 432 of the pilot case 125C on one hand, and is introduced into the variable chamber 441 through the orifice 416 of the base member 26C on the other hand. When the working fluid L is introduced into the variable chamber 441, in the valve member 131 that has been in contact with the seat part 413, the disc 127, and the disc 421, the valve disc 291 thereof deforms into a tapered shape in a direction in which the outer circumferential side thereof is separated from the seat part 413 using a contact point with the disc 127 as a fulcrum. At that time, the valve member 131 discharges the working fluid L from the communication chamber 442 to the reservoir chamber 6 through the passage 229C.

Here, in a high-frequency compression stroke in which a piston frequency is equal to or higher than a predetermined value, a stroke of the piston 18 is small. Therefore, an amount of the working fluid L introduced from the lower chamber 20 into the variable chamber 441 via the first passage 184, the orifice 242, the intermediate chamber 243, and the orifice 416 is small. Therefore, the valve member 131 deforms as described above, but does not deform to near the limit. As a result, although the working fluid L is introduced from the lower chamber 20 into the variable chamber 441, the valve member 131 of the frequency sensitive part 335C is deformed as described above each time the compression stroke occurs, thereby suppressing an increase in pressure of the variable chamber 441 and the back pressure chamber 301C.

During the high-frequency compression stroke in which the piston frequency is equal to or higher than the predetermined value, when a moving speed of the piston 18 (hereinafter referred to as a piston speed) is lower than a first predetermined value, the working fluid L from the lower chamber 20 flows into the reservoir chamber 6 through the fixed orifice 244 of the first damping force generation mechanism 251 in the flow path 252. Therefore, a damping force having orifice characteristics (in which the damping force is substantially proportional to the square of the piston speed) is generated. Therefore, the damping force characteristics with respect to the piston speed when the piston speed is lower than the first predetermined value are such that an increasing rate of the damping force with respect to an increase in the piston speed is relatively high.

In the high-frequency compression stroke in which the piston frequency is equal to or higher than the predetermined value, since an increase in pressure in the back pressure chamber 301C and the variable chamber 441 is suppressed as described above, the damping valve 250 of the first damping force generation mechanism 251C is easily opened. Therefore, when the piston speed is equal to or higher than the first predetermined value, the working fluid L from the lower chamber 20 opens the damping valve 250 of the first damping force generation mechanism 251C in the flow path 252 and flows into the reservoir chamber 6 through a gap between the damping valve 250 and the valve seat part 167. That is, the working fluid L from the lower chamber 20 flows into the reservoir chamber 6 through the flow path 252. Therefore, a damping force having valve characteristics (in which the damping force is substantially proportional to the piston speed) is generated. Therefore, the damping force characteristics with respect to the piston speed when the piston speed is equal to or higher than the first predetermined value are such that an increasing rate of the damping force with respect to an increase in the piston speed is lower than that when the piston speed is lower than the first predetermined value. Further, during the high-frequency compression stroke in which the piston frequency is equal to or higher than the predetermined value, the second damping force generation mechanism 332C does not open the disc valve 315.

“Compression Stroke in which Piston Frequency is Lower than Predetermined Value”

In a low-frequency compression stroke in which the piston frequency is lower than the predetermined value, the stroke of the piston 18 is large. Therefore, an amount of the working fluid L introduced from the lower chamber 20 into the variable chamber 441 via the first passage 184, the orifice 242 of the disc 141, the intermediate chamber 243 of the pin member 71C, and the orifice 416 of the base member 26C is large. Therefore, although the working fluid L flows from the lower chamber 20 to the variable chamber 441 at the beginning of the stroke of the piston 18, thereafter, the valve member 131 deforms to near the limit and does not deform more than that. As a result, even at the same piston speed, when the piston frequency is a low frequency lower than the predetermined value, a pressure in the back pressure chamber 301C into which the working fluid L is introduced from the intermediate chamber 243 through the orifice 432 of the pilot case 125C becomes higher than that when the piston frequency is a high frequency equal to or higher than the predetermined value.

During the low-frequency compression stroke in which the piston frequency is lower than the predetermined value as described above, when the moving speed of the piston 18 is lower than a third predetermined value, the working fluid L from the lower chamber 20 flows into the reservoir chamber 6 through the fixed orifice 244 of the first damping force generation mechanism 251C in the flow path 252. Therefore, a damping force having orifice characteristics is generated. Therefore, the damping force characteristics with respect to the piston speed when the piston speed is lower than the third predetermined value are such that an increasing rate of the damping force with respect to an increase in the piston speed is relatively high.

In the low-frequency compression stroke in which the piston frequency is lower than the predetermined value, since the pressure in the back pressure chamber 301C increases as described above, the damping valve 250 of the first damping force generation mechanism 251C is difficult to open. Therefore, when the piston speed is equal to or higher than the third predetermined value and lower than a fourth predetermined value, the working fluid L from the lower chamber 20 passes through the first passage 184, the orifice 242 of the disc 141, the intermediate chamber 243 of the pin member 71C, the orifice 432 of the pilot case 125C, and the back pressure chamber 301C, all of which constitute the flow path 331C, without opening the damping valve 250 of the first damping force generation mechanism 251C in the flow path 252, and then flows into the reservoir chamber 6 through between the disc valve 315 and the valve seat part 225C while opening the disc valve 315 of the second damping force generation mechanism 332C. Therefore, a damping force having valve characteristics is generated. Therefore, the damping force characteristics with respect to the piston speed when the piston speed is equal to or higher than the third predetermined value and lower than the fourth predetermined value are such that an increasing rate of the damping force with respect to an increase in the piston speed is lower than that when the piston speed is lower than the third predetermined value.

When the piston speed is equal to or higher than a fourth predetermined value, the working fluid L from the lower chamber 20 flows into the reservoir chamber 6 while opening the disc valve 315 of the second damping force generation mechanism 332C, and also flows into the reservoir chamber 6 through the flow path 252 including a gap between the damping valve 250 and the valve seat part 167 while opening the damping valve 250 of the first damping force generation mechanism 251C in which an opening thereof has been restricted due to the pressure in the back pressure chamber 301C. Therefore, the damping force characteristics with respect to the piston speed when the piston speed is equal to or higher than the fourth predetermined value are such that an increasing rate of the damping force with respect to an increase in the piston speed is lower than that when the piston speed is equal to or higher than the third predetermined value and lower than the fourth predetermined value.

In the base valve 25C, even if the piston speed is the same, during the low-frequency compression stroke in which the piston frequency is lower than the predetermined value, the pressure in the back pressure chamber 301C is higher than that during the high-frequency compression stroke in which the piston frequency is equal to or higher than the predetermined value. Therefore, even if the piston speed is the same, during the low-frequency compression stroke in which the piston frequency is lower than the predetermined value, the damping valve 250 of the first damping force generation mechanism 251C is more difficult to open than during the high-frequency compression stroke in which the piston frequency is equal to or higher than the predetermined value. Thereby, even if the piston speed is the same, during the low-frequency compression stroke in which the piston frequency is lower than the predetermined value, the damping force exhibits harder characteristics than during the high-frequency compression stroke in which the piston frequency is equal to or higher than the predetermined value.

### [Extension Stroke]

In the extension stroke, the pressure in the lower chamber 20 becomes lower than the pressure in the reservoir chamber 6, but the valve disc 291 of the valve member 131 of the frequency sensitive part 335C comes into contact with the seat part 413 of the base member 26C to suppress expansion of the communication chamber 442. Therefore, an amount of the working fluid L introduced from the reservoir chamber 6 into the communication chamber 442 through the passage 229C is suppressed. As a result, a flow rate of the working fluid L introduced from the reservoir chamber 6 into the first passage 194, passing through the first damping force generation mechanism 355C, and flowing into the lower chamber 20 does not decrease. Therefore, the damping force is almost the same as when the frequency sensitive part 335C is not provided.

In the extension stroke, when the piston speed is lower than a fifth predetermined value, the working fluid L from the reservoir chamber 6 flows into the lower chamber 20 through the fixed orifice 341B of the first damping force generation mechanism 355C in the flow path 356. Therefore, a damping force having orifice characteristics (in which the damping force is substantially proportional to the square of the piston speed) is generated. Therefore, the damping force characteristics with respect to the piston speed when the piston speed is lower than the fifth predetermined value are such that an increasing rate of the damping force with respect to an increase in the piston speed is relatively high.

In the extension stroke, when the piston speed is equal to or higher than the fifth predetermined value, the working fluid L from the reservoir chamber 6 opens the valve disc 145C of the first damping force generation mechanism 355C in the flow path 356 and flows into the lower chamber 20 through a gap between the valve disc 145C and the valve seat part 163. Therefore, a damping force having valve characteristics (in which the damping force is substantially proportional to the piston speed) is generated. Therefore, the damping force characteristics with respect to the piston speed when the piston speed is equal to or higher than the fifth predetermined value are such that an increasing rate of the damping force with respect to an increase in the piston speed is lower than that when the piston speed is lower than the fifth predetermined value.

Here, in the extension stroke, when the piston speed increases and a pressure in the communication chamber 442 becomes higher than the pressure in the variable chamber 441 by a predetermined value or more, the inner circumferential side of the valve member 131 separates from the disc 127. In other words, the check valve 338C opens. Thereby, the working fluid L flows from the reservoir chamber 6 to the lower chamber 20 via the passage 229C, the communication chamber 442, the check valve 338C in an open state, the variable chamber 441, the orifice 416 of the base member 26C, the intermediate chamber 243 of the pin member 71C, the orifice 242 of the disc 141, and the first passage 184, all of which constitute the flow path 331C. That is, the working fluid L flows from the reservoir chamber 6 to the lower chamber 20 through the flow path 331C. In this way, the valve member 131 reduces a differential pressure between the communication chamber 442 side and the variable chamber 441 side when the check valve 338C opens. Therefore, excessive bending of the valve member 131 is suppressed.

In the shock absorber 1C of the third embodiment, the base member 26C is disposed on the bottom part 12 side of the partition member 142, and the frequency sensitive part 335C is provided on the bottom part 12 side of the base member 26C. Thereby, in the shock absorber 1C, the pilot case retainer 135 is not necessary, costs can be reduced, and the base valve 25C can be made smaller in size in the axial direction.

Further, in the shock absorbers 1, 1A, 1B, and 1C of the first to fourth embodiments, cases in which the reservoir chamber 6 is provided in the cylinders 2, 2A, 2B, and 2C have been described as an example. The present invention is not limited thereto, and the present invention is also applicable to cases in which the reservoir chamber is provided in a tank separate from the cylinders 2, 2A, 2B, and 2C. Also, in a single-tube type shock absorber, in addition to the two chambers partitioned by a piston inside the cylinder, a free piston for partitioning one of the two chambers and a gas chamber can be slidably provided. The present invention can also be applied to the case of the free piston. In this case, the shock absorber can be used in an inverted state in which the piston rod extends downward from the cylinder.

According to a first aspect of the embodiment described above, a shock absorber has a cylinder having a bottomed cylindrical shape in which a working fluid is sealed, a piston provided inside the cylinder and dividing the inside of the cylinder into two cylinder chambers, a piston rod to which the piston is fastened, and a reservoir chamber in which the working fluid and a gas are sealed, and the shock absorber includes a partition member partitioning the cylinder chamber in the cylinder and the reservoir chamber and including a first partition member having a first flow path which allows communication between the cylinder chamber and the reservoir chamber, and a frequency sensitive part provided on a bottom part side of the cylinder with respect to the first partition member and to which the working fluid is supplied through the first flow path.

According to a second embodiment, in the first aspect, a second partition member is disposed on the bottom part side of the cylinder with respect to the frequency sensitive part, and an axial force of the cylinder is applied to the second partition member.

According to a third aspect, in the second aspect, the first partition member, the frequency sensitive part, and the second partition member are fixed to a shaft member penetrating the first partition member, the frequency sensitive part, and the second partition member.

According to a fourth aspect, in the first or second aspect, a hole is formed in the cylinder between the first partition member and the second partition member.

According to a fifth aspect, in any one of the second to fourth aspects, the first partition member and the second partition member have different hardnesses.

According to a sixth aspect, in any one of the second to fifth aspects, the first partition member and the second partition member have different materials.

According to a seventh aspect, in any one of the first to sixth aspects, a second partition member is disposed on the bottom part side of the cylinder with respect to the first partition member, the frequency sensitive part is provided on the bottom part side of the cylinder with respect to the second partition member, and an axial force of the cylinder is applied to the second partition member.

### INDUSTRIAL APPLICABILITY

According to the shock absorber described above, it is possible to secure a flow path area of a flow path that introduces a working fluid into a frequency sensitive part.

### REFERENCE SIGNS LIST

1, 1A, 1B, 1C Shock absorber
2, 2A, 2B Cylinder
6 Reservoir chamber
12 Bottom part
18 Piston
19 Upper chamber (cylinder chamber)
20 Lower chamber (cylinder chamber)
21 Piston rod
25, 25A, 25B, 25C Base valve (partition member)
26, 26B, 26C Base member (second partition member)
71, 71B, 71C Pin member (shaft member)
142 Partition member (first partition member)
331, 331C Flow path (first flow path)
335, 335C Frequency sensitive part
381 Hole
L Working fluid
G Gas

1. A shock absorber including:
a cylinder having a bottomed cylindrical shape in which a working fluid is sealed;
a piston provided inside the cylinder and dividing an inside of the cylinder into two cylinder chambers;
a piston rod to which the piston is fastened; and
a reservoir chamber in which the working fluid and a gas are sealed,
the shock absorber comprising a partition member partitioning the cylinder chamber in the cylinder and the reservoir chamber and including:
a first partition member having a first flow path which allows communication between the cylinder chamber and the reservoir chamber; and
a frequency sensitive part provided on a bottom part side of the cylinder with respect to the first partition member and to which the working fluid is supplied through the first flow path.

2. The shock absorber according to claim 1, wherein a second partition member is disposed on the bottom part side of the cylinder with respect to the frequency sensitive part, and an axial force of the cylinder is applied to the second partition member.

3. The shock absorber according to claim 2, wherein the first partition member, the frequency sensitive part, and the second partition member are fixed to a shaft member penetrating the first partition member, the frequency sensitive part, and the second partition member.

4. The shock absorber according to claim 2, wherein a hole is formed in the cylinder between the first partition member and the second partition member.

5. The shock absorber according to claim 2, wherein the first partition member and the second partition member have different hardnesses.

6. The shock absorber according to claim 2, wherein the first partition member and the second partition member have different materials.

7. The shock absorber according to claim 1, wherein
a second partition member is disposed on the bottom part side of the cylinder with respect to the first partition member,
the frequency sensitive part is provided on the bottom part side of the cylinder with respect to the second partition member, and
an axial force of the cylinder is applied to the second partition member.
